(19) United States
(12) Patent Application Publication
(10) Pub. No.: US 2021/0166613 A1
(43) Pub. Date: Jun. 3, 2021

(54) Display Driving System, Display Driving Method, and Display Device

(71) Applicants: BEIJING BOE DISPLAY TECHNOLOGY CO., LTD., Beijing (CN); BOE TECHNOLOGY GROUP CO., LTD., Beijing (CN)

(72) Inventors: Qiang ZHANG, Beijing (CN); Dianzheng DONG, Beijing (CN); Guangxing WANG, Beijing (CN); Wenpeng XU, Beijing (CN); Wan LIN, Beijing (CN); Haixu WANG, Beijing (CN); Leiyang WANG, Beijing (CN); Haiqin HUANG, Beijing (CN)

(21) Appl. No.: 17/106,586

(22) Filed: Nov. 30, 2020

(30) Foreign Application Priority Data
Nov. 29, 2019 (CN) 201911204200.8

(51) Int. Cl. G09G 3/20

(52) U.S. Cl. CPC G09G 3/2092; G09G 2300/0452; G09G 2310/0289; G09G 2310/08

(57) ABSTRACT

A display driving system includes a timing controller, a level shifter and a power supply circuit. The timing controller is configured to send first clock signals having a first level, a second level and a third level to the level shifter. The second level is less than the first level and greater than the third level. The power supply circuit is configured to output a first, second and third voltage signals to the level shifter. The second voltage signal has a second voltage less than a first voltage of the first voltage signal and greater than a third voltage of the third voltage signal. The level shifter is configured to transmit the first voltage in response to the first level, the second voltage to in response to the second level and the third voltage in response to the third level, to a gate driver circuit.

### CROSS-REFERENCE TO RELATED APPLICATION

This application claims priority to Chinese Patent Application No. 201911204200.8, filed Nov. 29, 2019, which is incorporated herein by reference in its entirety.

### TECHNICAL FIELD

The present disclosure relates to the field of display technologies, and in particular, to a display driving system, a display driving method, and a display device.

### BACKGROUND

In a driving process of a display screen, a gate driver circuit outputs scanning signals to gate lines, and the gate lines transmit the scanning signals to sub-pixels of the display screen; and a source driver circuit outputs data signals to data lines, and the data lines transmit the data signals to the sub-pixels, thereby realizing the driving of the display screen.

### SUMMARY

In one aspect, a display driving system is provided. The display driving system includes a timing controller, a level shifter and a power supply circuit. The timing controller is electrically connected to the level shifter, and is configured to send a plurality of first clock signals to the level shifter when an image to be displayed is a target image; the first clock signals have a first level, a second level and a third level, and a voltage of the second level is less than a voltage of the first level and is greater than a voltage of the third level. The power supply circuit is electrically connected to the level shifter, and is configured to output a first voltage signal, a second voltage signal and a third voltage signal to the level shifter a second voltage of the second voltage signal is less than a first voltage of the first voltage signal and is greater than a third voltage of the third voltage signal. The level shifter is configured to transmit a plurality of first control signals that have the first voltage, the second voltage and the third voltage to a gate driver circuit, which includes: transmitting the first voltage of the plurality of first control signals to the gate driver circuit in response to the first level of the first clock signals; transmitting the second voltage of the plurality of first control signals to the gate driver circuit in response to the second level of the first clock signals; and transmitting the third voltage of the plurality of first control signals to the gate driver circuit in response to the third level of the first clock signals.

In some embodiments, the power supply circuit includes a power management integrated circuit and a buck regulator electrically connected to the power management integrated circuit; the power management integrated circuit is electrically connected to the level shifter, and is configured to: output the first voltage signal and the third voltage signal to the level shifter, and output the first voltage signal to the buck regulator; and the buck regulator is electrically connected to the level shifter, and is configured to: convert the first voltage signal into the second voltage signal, and transmit the second voltage signal to the level shifter.

In some embodiments, the buck regulator is a low dropout regulator or a buck converter.

In some embodiments, the first clock signals include a plurality of first sub-clock signals and a plurality of second sub-clock signals, each first sub-clock signal has the first level and the third level, and each second sub-clock signal has the second level and the third level; the first control signals include a plurality of first sub-control signals and a plurality of second sub-control signals, each first sub-control signal has the first voltage and the third voltage, and each second sub-control signal has the second voltage and the third voltage. The level shifter is configured to: transmit first voltages of the first sub-control signals to a plurality of first GOA units of the gate driver circuit in response to first levels of the first sub-clock signals, so that each first GOA unit provides a first scanning sub-signal to one of odd sub-pixel rows and even pixel rows; transmit second voltages of the second sub-control signals to a plurality of second GOA units of the gate driver circuit in response to second levels of the second sub-clock signals, so that each second GOA unit provides a second scanning sub-signal to another of the odd sub-pixel rows and the even pixel rows; and transmit third voltages of the first sub-control signals and the second sub-control signals to the first GOA units and the second GOA units in response to third levels of the first sub-clock signals and third levels of the second sub-clock signals, respectively.

In some embodiments, a cycle of each first clock signal includes a high-level clock period and a low-level clock period; the high-level clock period includes at least a first high-level clock sub-period and a second high-level clock sub-period adjacent thereto, and the first high-level clock sub-period and the second high-level clock sub-period are sequentially arranged; the first clock signal has the first level in the first high-level clock sub-period, has the second level in the second high-level clock sub-period, and has the third level in the low-level clock period; a cycle of each first control signal includes a high-level control period and a low-level control period; the high-level control period includes at least a first high-level control sub-period and a second high-level control sub-period adjacent thereto, and the first high-level control sub-period and the second high-level control sub-period are sequentially arranged; the first control signal has the first voltage in the first high-level control sub-period, has the second voltage in the second high-level control sub-period, and has the third voltage in the low-level control period. The level shifter is configured to: for each first clock signal, transmit the first voltage of the first control signal in the first high-level control sub-period to the gate driver circuit in response to the first level of the first clock signal in the first high-level clock sub-period; transmit the second voltage of the first control signal in the second high-level control sub-period to the gate driver circuit in response to the second level of the first clock signal in the second high-level clock sub-period; and transmit the third voltage of the first control signal in the low-level control period to the gate driver circuit in response to the third level of the first clock signal in the low-level clock period.

In some embodiments, the high-level clock period of the first clock signal further includes a third high-level clock sub-period that is adjacent to and subsequent to the second high-level clock sub-period, and the first clock signal has the first level in the third high-level clock sub-period; the high-level control period of the first control signal further includes a third high-level control sub-period that is adjacent to and subsequent to the second high-level control sub-period, and the first control signal has the first voltage in the third high-level control sub-period. The level shifter is further configured to transmit the first voltage of the first control signal in the third high-level control sub-period to the gate driver circuit in response to the first level of the first clock signal in the third high-level clock sub-period.

In some embodiments, the voltage of the first level is in a range from 2.5V to 3.3 V, the voltage of the second level is in a range from 1.2 V to 1.8 V, and the voltage of the third level is in a range from 0 V to 0.7 V.

In some embodiments, the timing controller the timing controller is further configured to: obtain image data corresponding to the image to be displayed; determine a ratio of a number of target pixels in the image to be displayed to a total number of pixels in the image to be displayed according to the obtained image data, wherein each pixel of the image to be displayed includes three color components, and each target pixel is a pixel in which two of the three color components are both greater than or equal to a first threshold, and a remaining color component is less than or equal to a second threshold; one of the two color components is a green color component, and the first threshold is greater than the second threshold; and determine that the image to be displayed is the target image when the ratio is greater than a set value.

In some embodiments, the target pixel is a pixel of the image to be displayed in which two color components are equal to or approximately equal to a maximum value, and a remaining color component is equal to or approximately equal to a minimum value.

In some embodiments, when the image to be displayed is not the target image, the timing controller is further configured to send a plurality of second clock signals to the level shifter, wherein each second clock signal has the first level and the third level; and the level shifter is further configured to transmit a plurality of second control signals each of which has the first voltage and the third voltage to the gate driver circuit, which includes: transmitting first voltages of the second sub-control signals to the gate driver circuit in response to first levels of the second clock signals; and transmitting third voltages of the second control signals to the gate driver circuit in response to third levels of the second clock signals.

In another aspect, a display driving method performed at a display driving system is provided. The method includes: when an image to be displayed is a target image, sending, by a timing controller of the display driving system, a plurality of first clock signals to a level shifter of the display driving system, wherein the first clock signals have a first level, a second level and a third level, and a voltage of the second level is less than a voltage of the first level and is greater than a voltage of the third level; outputting, by a power supply circuit of the display driving system, a first voltage signal, a second voltage signal and a third voltage signal to the level shifter, wherein a second voltage of the second voltage signal is less than a first voltage of the first voltage signal and is greater than a third voltage of the third voltage signal; transmitting, by the level shifter, the first voltage of a plurality of first control signals that have the first voltage, the second voltage and the third voltage to a gate driver circuit in response to the first level of the first clock signals; transmitting, by the level shifter, the second voltage of the plurality of first control signals to the gate driver circuit in response to the second level of the first clock signals; and transmitting, by the level shifter, the third voltage of the plurality of first control signals to the gate driver circuit in response to the third level of the first clock signals.

In some embodiments, the power supply circuit includes a power management integrated circuit and a buck regulator electrically connected to the power management integrated circuit. Outputting, by the power supply circuit, the first voltage signal, the second voltage signal and the third voltage signal to the level shifter includes: outputting, by the power management integrated circuit, the first voltage signal and the third voltage signal to the level shifter; outputting, by the power management integrated circuit, the first voltage signal to the buck regulator; converting, by the buck regulator, the first voltage signal into the second voltage signal; and transmitting, by the buck regulator, the second voltage signal to the level shifter.

In some embodiments, the first clock signals include a plurality of first sub-clock signals and a plurality of second sub-clock signals, each first sub-clock signal has the first level and the third level, and each second sub-clock signal has the second level and the third level; the first control signals include a plurality of first sub-control signals and a plurality of second sub-control signals, each first sub-control signal has the first voltage and the third voltage, and each second sub-control signal has the second voltage and the third voltage. Transmitting, by the level shifter, the first voltage of the plurality of first control signals to the gate driver circuit in response to the first level of the first clock signals, transmitting, by the level shifter, the second voltage of the plurality of first control signals to the gate driver circuit in response to the second level of the first clock signals, and transmitting, by the level shifter, the third voltage of the plurality of first control signals to the gate driver circuit in response to the third level of the first clock signals, include: transmitting, by the level shifter, first voltages of the first sub-control signals to a plurality of first GOA units of the gate driver circuit in response to first levels of the first sub-clock signals, so that each first GOA unit provides a first scanning sub-signal to one of odd sub-pixel rows and even pixel rows; transmitting, by the level shifter, second voltages of the first sub-control signals to a plurality of second GOA units of the gate driver circuit in response to second levels of the second sub-dock signals, so that each second GOA unit provides a second scanning sub-signal to another of the odd sub-pixel rows and the even pixel rows; and transmitting, by the level shifter, third voltages of the first sub-control signals and the second sub-control signals to the first GOA units and the second GOA units in response to third levels of the first sub-clock signals and third levels of the second sub-dock signals, respectively.

In some embodiments, a cycle of each first clock signal includes a high-level clock period and a low-level dock period; the high-level dock period includes at least a first high-level clock sub-period and a second high-level clock sub-period adjacent thereto, and the first high-level dock sub-period and the second high-level dock sub-period are sequentially arranged; the first dock signal has the first level in the first high-level clock sub-period, has the second level in the second high-level dock sub-period, and has the third level in the low-level clock period; a cycle of each first control signal includes a high-level control period and a low-level control period; the high-level control period includes at least a first high-level control sub-period and a second high-level control sub-period adjacent thereto, and the first high-level control sub-period and the second high-level control sub-period are sequentially arranged; the first control signal has the first voltage in the first high-level control sub-period, has the second voltage in the second high-level control sub-period, and has the third voltage in the low-level control period. Transmitting, by the level shifter, the first voltage of the plurality of first control signals to the gate driver circuit in response to the first level of the first dock signals, transmitting, by the level shifter, the second voltage of the plurality of first control signals to the gate driver circuit in response to the second level of the first dock signals, and transmitting, by the level shifter, the third voltage of the plurality of first control signals to the gate driver circuit in response to the third level of the first dock signals include: for each first dock signal, transmitting, by the level shifter, the first voltage of the first control signal in the first high-level control sub-period to the gate driver circuit in response to the first level of the first clock signal in the first high-level clock sub-period; transmitting, by the level shifter, the second voltage of the first control signal in the second high-level control sub-period to the gate driver circuit in response to the second level of the first clock signal in the second high-level clock sub-period; and transmitting, by the level shifter, the third voltage of the first control signal in the low-level control period to the gate driver circuit in response to the third level of the first clock signal in the low-level clock period.

In some embodiments, the high-level clock period of the first clock signal further includes a third high-level clock sub-period that is adjacent to and subsequent to the second high-level clock sub-period, and the first clock signal has the first level in the third high-level clock sub-period; the high-level control period of the first control signal further includes a third high-level control sub-period that is adjacent to and subsequent to the second high-level control sub-period, and the first control signal has the first voltage in the third high-level control sub-period. Transmitting, by the level shifter, the first voltage of the plurality of first control signals to the gate driver circuit in response to the first level of the first clock signals, transmitting, by the level shifter, the second voltage of the plurality of first control signals to the gate driver circuit in response to the second level of the first clock signals, and transmitting, by the level shifter, the third voltage of the plurality of first control signals to the gate driver circuit in response to the third level of the first clock signals further include: for each first clock signal, transmitting, by the level shifter, the first voltage of the first control signal in the third high-level control sub-period to the gate driver circuit in response to the first level of the first clock signal in the third high-level clock sub-period.

In some embodiments, the voltage of the first level is in a range from 2.5 V to 3.3 V, the voltage of the second level is in a range from 1.2 V to 1.8 V, and the voltage of the third level is in a range from 0 V to 0.7 V.

In some embodiments, before the timing controller sends the first clock signals to the level shifter, the method further includes: obtaining, by the timing controller, image data corresponding to the image to be displayed; determining, by the timing controller, a ratio of a number of target pixels in the image to be displayed to a total number of pixels in the image to be displayed according to the obtained image data, wherein each pixel of the image to be displayed includes three color components, and each target pixel is a pixel in which two of the three color components are both greater than or equal to a first threshold, and a remaining color component is less than or equal to a second threshold; one of the two color components is a green color component, and the first threshold is greater than the second threshold; and determining, by the timing controller, that the image to be displayed is the target image when the ratio is greater than a set value.

In yet another aspect, a display device is provided. The display device includes a timing controller, a level shifter, a power supply circuit, a gate driver circuit and a plurality of sub-pixel rows. The timing controller is electrically connected to the level shifter, and is configured to send a plurality of first clock signals to the level shifter when an image to be displayed is a target image; the first clock signals have a first level, a second level and a third level, and a voltage of the second level is less than a voltage of the first level and is greater than a voltage of the third level. The power supply circuit is electrically connected to the level shifter, and is configured to output a first voltage signal, a second voltage signal and a third voltage signal to the level shifter; a second voltage of the second voltage signal is less than a first voltage of the first voltage signal and is greater than a third voltage of the third voltage signal. The level shifter is configured to transmit a plurality of first control signals that have the first voltage, the second voltage and the third voltage to the gate driver circuit, which includes: transmitting the first voltage of the plurality of first control signals to the gate driver circuit in response to the first level of the first clock signals; transmitting the second voltage of the plurality of first control signals to the gate driver circuit in response to the second level of the first clock signals; and transmitting the third voltage of the plurality of first control signals to the gate driver circuit in response to the third level of the first clock signals. The gate driver circuit include a plurality of GOA units, each GOA unit is electrically connected to a respective one of the plurality of sub-pixel rows, and the GOA unit is configured to output a first scanning signal to a corresponding sub-pixel row according to a first control signal provided by the level shifter.

In some embodiments, the first clock signals includes a plurality of first sub-clock signals and a plurality of second sub-clock signals, each first sub-clock signal has the first level and the third level, and each second sub-clock signal has the second level and the third level; the first control signals include a plurality of first sub-control signals and a plurality of second sub-control signals, each first sub-control signal has the first voltage and the third voltage, and each second sub-control signal has the second voltage and the third voltage; the GOA units include a plurality of first GOA units and a plurality of second GOA units; each first GOA unit is configured to provide a first scanning sub-signal to one of odd sub-pixel rows and even pixel rows, and each second GOA unit is configured to provide a second scanning sub-signal to another of the even sub-pixel rows and the even pixel rows. The level shifter is configured to: transmit first voltages of the first sub-control signals to the first GOA units in response to first levels of the first sub-clock signals, so that each first GOA unit provides a first scanning sub-signal to one of odd sub-pixel rows and even pixel rows; transmit second voltages of the second sub-control signals to the second GOA units in response to second levels of the second sub-clock signals, so that each second GOA unit provides a second scanning sub-signal to another of the odd sub-pixel rows and the even pixel rows; and transmit third voltages of the first sub-control signals and the second sub-control signals to the first GOA units and the second GOA units in response to third levels of the first sub-clock signals and third levels of the second sub-clock signals, respectively.

In some embodiments, the timing controller is further configured to send a plurality of second clock signals to the level shifter when the image to be displayed is not the target image; each second clock signal has the first level and the third level. The power supply circuit is further configured to output the first voltage signal and the third voltage signal to the level shifter. The level shifter is further configured to transmit a plurality of second control signals each of which has the first voltage and the third voltage to the GOA units, which includes: transmitting first voltages of second control signals to the GOA units in response to first levels of the second clock signals; and transmitting third voltages of second control signals to the GOA units in response to third levels of the second clock signals. Each GOA unit is further configured to output a second scanning signal to the corresponding sub-pixel row according to a corresponding second control signal provided by the level shifter.

### BRIEF DESCRIPTION OF THE DRAWINGS

In order to describe technical solutions in the present disclosure more clearly, accompanying drawings to be used in some embodiments of the present disclosure will be introduced briefly below. However, the accompanying drawings to be described below are merely accompanying drawings of some embodiments of the present disclosure, and a person of ordinary skill in the art can obtain other drawings according to these drawings.

In addition, the accompanying drawings to be described below may be regarded as schematic diagrams, and are not limitations on actual sizes of products, an actual process of a method and actual timings of signals to which the embodiments of the present disclosure relate.

FIG. 1 is a schematic top view of a 1G1D display panel;

FIG. 2 is a schematic top view of a 2G2D display panel;

FIG. 3 is a schematic diagram of a gate driver circuit;

FIG. 4 is a waveform diagram of a data signal in the related art, which can be provided to the display panel in FIG. 1;

FIG. 5 is a waveform diagram of another data signal in the related art, which can be provided to the display panel in FIG. 1;

FIG. 6 is a schematic diagram of the display panel in FIG. 1 displaying a target image;

FIG. 7 is a schematic diagram of the display panel in FIG. 2 displaying a target image;

FIG. 8 is a waveform diagram of yet another data signal in the related art, which can be provided to the display panel in FIG. 2;

FIG. 9 is a waveform diagram of yet another data signal in the related art, which can be provided to the display panel in FIG. 2;

FIG. 10 is a schematic diagram of a display driving system, in accordance with some embodiments;

FIG. 11 is a schematic diagram of another display driving system, in accordance with some embodiments;

FIG. 12A is a waveform diagram of a first clock signal, in accordance with some embodiments;

FIG. 12B is a waveform diagram of a first control signal, in accordance with some embodiments;

FIG. 13A is a waveform diagram of another first clock signal, in accordance with some embodiments:

FIG. 13B is a waveform diagram of another first control signal, in accordance with some embodiments;

FIG. 14 is a flow diagram of a display driving method, in accordance with some embodiments;

FIG. 15 is a flow diagram of another display driving method, in accordance with some embodiments;

FIG. 16 is a flow diagram of yet another display driving method, in accordance with some embodiments;

FIG. 17 is a flow diagram of yet another display driving method, in accordance with some embodiments;

FIG. 18 is a signal timing diagram of a display driving method, in accordance with some embodiments; and

FIG. 19 is a signal timing diagram of another display driving method, in accordance with some embodiments.

### DETAILED DESCRIPTION

Technical solutions in some embodiments of the present disclosure will be described clearly and completely in combination with the accompanying drawings.

However, the described embodiments are merely some but not all embodiments of the present disclosure. All other embodiments obtained on a basis of the embodiments of the present disclosure by a person of ordinary skill in the art shall be included in the protection scope of the present disclosure.

Unless the context requires otherwise, throughout the description and claims, the term “comprise” and other forms thereof such as the third-person singular form “comprises” and the present participle form “comprising” are construed as an open and inclusive meaning, i.e., “included, but not limited to”. In the description of the specification, terms such as “one embodiment”, “some embodiments”, “exemplary embodiments”, “example”, “specific example”, or “some examples” are intended to indicate that specific features, structures, materials or characteristics related to the embodiment(s) or example(s) are included in at least one embodiment or example of the present disclosure.

Schematic representations of the above terms do not necessarily refer to the same embodiment(s) or example(s). In addition, the specific features, structures, materials or characteristics may be included in any one or more embodiments/examples in any suitable manner.

Terms such as “first” and “second” are only used for descriptive purposes, and are not to be construed as indicating or implying the relative importance or implicitly indicating the number of indicated technical features below. Thus, features defined by “first” and “second” may explicitly or implicitly include one or more of the features. In the description of the embodiments of the present disclosure, the term “a plurality of”/the plurality of means two or more unless otherwise specified.

In the description of some embodiments, terms such as “coupled” and “connected” and their extensions may be used. For example, the term “connected” may be used in the description of some embodiments to indicate that two or more components are in direct physical or electrical contact with each other. For another example, the term “coupled” may be used in the description of some embodiments to indicate that two or more components are in direct physical or electrical contact. However, the term “coupled” or “communicatively coupled” may also mean that two or more elements are not in direct contact with each other, but still cooperate or interact with each other. The embodiments disclosed herein are not necessarily limited to the contents herein.

The term “about”, “substantially” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). “A and/or B” includes the following combinations of A and B: only A, only B, and a combination of A and B.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It will be noted that, the embodiments and the features of the embodiments in the present disclosure may be combined with each other if there is no conflict therebetween.

A display panel of a display device includes a plurality of pixels, and each pixel may include a plurality of sub-pixels, such as three or four sub-pixels. For example, each pixel of the display panel includes a green sub-pixel, a blue sub-pixel and a red sub-pixel. It will be noted that, a pixel of an image refers to a minimum unit constituting the image, which is a different concept from a pixel having a physical structure in the display panel. In a case where image resolution of an image is equal to screen resolution of the display panel, each pixel of the image corresponds to a respective one of pixels of the display panel.

During a driving process of the display device, sub-pixels of the display panel are turned on under control of scanning signals transmitted by gate lines, and then data signals transmitted by data lines are written into capacitors of the sub-pixels, so that the sub-pixels can be provided with pixel voltages required for displaying gray scales. It will be noted that, a grayscale value of a sub-pixel is related to a magnitude of the pixel voltage, i.e., related to the written data signal. In this way, a pixel of the image corresponding to each pixel of the display panel presents a corresponding gray scale, so that the display device can realize an image display.

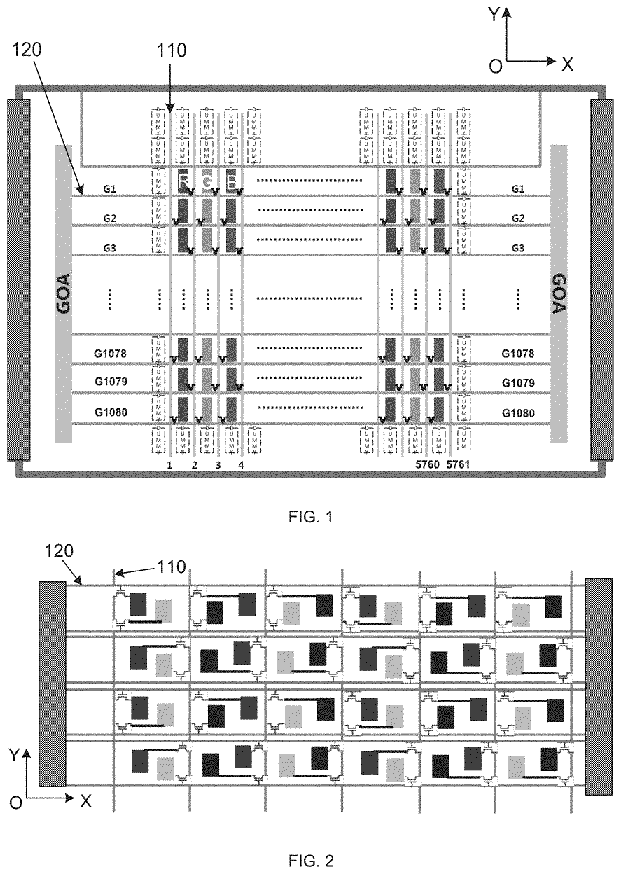

FIGS. 1 and 2 show display panels of two structures. In these two types of display panels, connection points between a data line and sub-pixels, connected to the data line, in adjacent columns of sub-pixels are arranged in a left-right alternating manner. Since in such display panels, connection points between each dataline and sub-pixels connected to this data line are substantially arranged in a Z shape, these display panels may also be referred to as Z-structure display panels.

As shown in FIG. 1, the 1G1D display panel is illustrated by taking an example in which each sub-pixel of each odd sub-pixel row (i.e., a sub-pixel row whose sequence number is an odd) is connected to a data line 110 located at its right side, and each sub-pixel of each even sub-pixel row (i.e., a sub-pixel row whose sequence number is an even) is connected to a data line 110 located at its left side. Of course, in some other examples, each sub-pixel of each odd sub-pixel row is connected to a data line 110 located at its left side, and each sub-pixel of each even sub-pixel row is connected to a data line 110 located at its right side.

A screen resolution of the display panel is 1920 by 1080. That is, as shown in FIG. 1, the display panel has 1920 pixels in a first direction OX and 1080 pixels in a second direction OY. Each pixel may include a red sub-pixel, a green sub-pixel and a blue sub-pixel arranged substantially in the first direction OX. That is, the display panel has a total of 5760 sub-pixels in the first direction OX. Here, the first direction OX is substantially parallel to an extension direction of a row of sub-pixels, and the second direction OY is substantially parallel to an extension direction of a column of sub-pixels.

The display panel has 5761 data lines 110. A data line 110 with a sequence number 1 is only used to drive part of sub-pixels in the sub-pixel column located at the right side of the data line 110, and a data line 110 with a sequence number 5761 is only used to drive part of sub-pixels in the sub-pixel column located at the left side of the data line 110. Except the data lines 110 with sequence numbers 1 and 5761, each of the remaining data lines 110 may be used to drive part of sub-pixels in the sub-pixel columns located at both left and right sides of the data line 110. For example, a data line with a sequence number 2 in the display panel is alternately connected to a red sub-pixel of the sub-pixel column located at the left side thereof and a green sub-pixel of the sub-pixel column located at the right side thereof from top to bottom in the second direction OY. For each sub-pixel column, sub-pixels in odd rows are driven from respective right sides of the sub-pixels, and sub-pixels in even rows are driven from respective left sides of the sub-pixels. That is, driving directions of sub-pixels in each sub-pixel column are changed every row. The display panel also has 1080 gate lines 120, and each gate line 120 is used to drive one sub-pixel row. Such a display panel in which each gate line is used to drive one sub-pixel row and each data line is used to drive one sub-pixel in the sub-pixel row may be referred to as a 1G1D display screen.

For another example, FIG. 2 shows a 2G2D display panel. The 2G2D display panel is different from the 1G1D display panel in that, each sub-pixel row of the 2G2D display panel is driven by two gate lines 120, and there are two adjacent sub-pixels in the sub-pixel row that are driven through different gate lines 120; and each data line is connected to two adjacent sub-pixels in a same sub-pixel row, that is, the two adjacent sub-pixels in the same sub-pixel row may be driven through the data line. It will be noted that, in a case where the screen resolution is constant, the number of data lines 110 in the 2G2D display panel may be reduced by half, so that the number of source driver chips and/or the number of the interfaces between the data lines and the source driver chips may be reduced.

Such a display panel in which each row of sub-pixels is driven through two gate lines and each data line is used to drive two adjacent sub-pixels in one sub-pixel row is also referred to as a 2G2D display screen.

The display panel may be a liquid crystal display (LCD) panel, or an organic light-emitting diode (OLED) display panel. The following embodiments are described by taking the OLED display panel as an example, and the display panel of another type may be referred to the description of the OLED display panel.

When the 1G1D display panel display an image, in an example where a high level of a scanning signal is used for turning on a switching transistor inside a sub-pixel whose gate is electrically connected to the gate line, in a charging period of the sub-pixel, the scanning signal Vg received by the gate line is at a high level, so that the switching transistor of the sub-pixel is turned on. Since the switching transistor is turned on, a corresponding data line may write a data signal into a capacitor of the sub-pixel, thereby charging the sub-pixel.

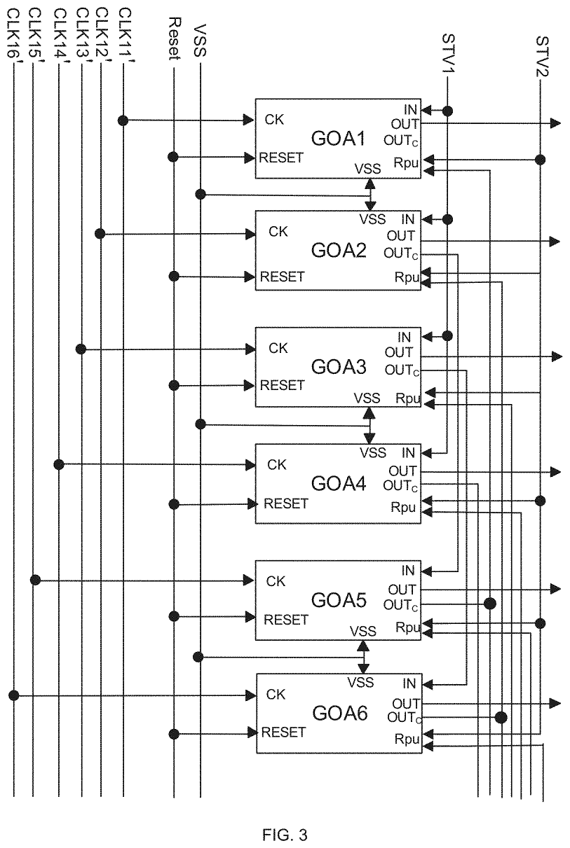

As shown in FIG. 3, the gate driver circuit of the display device includes a plurality of cascaded GOA units, and in addition to outputting an output signal serving as the scanning signal Vg to a corresponding sub-pixel through a terminal OUT and a gate line, a N-th GOA unit may also output this output signal to another M-th GOA unit located in the same group of GOA units therewith, for example, the output signal serves as a reset signal of the M-th GOA unit. In this case, the reset period may be after the scanning period, and thus the signal output by the N-th GOA unit has an active level (e.g., a high level) that is long enough to cover both the scanning period of the sub-pixel row and the reset period of M-th GOA unit. As a result, a duration of an active level of the scanning signal Vg (i.e., a sum of a T1 period and a T2 period) received by a sub-pixel corresponding to N-th GOA unit may include the T1 period (which may be referred to as a pre-charging period of the sub-pixel) and the T2 period (which is an actual charging period T2 of the sub-pixel).

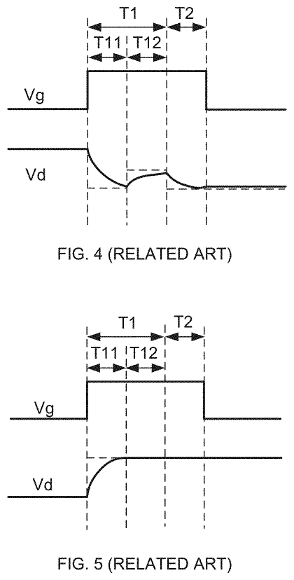

When the data signals shown in FIGS. 4 and 5 are provided to the 1G1D display panel to make the 1G1D display panel to display images, bright and dark stripes may appear on the images.

For example, when an image to be displayed is a cyan image or a yellow image, an image displayed by the 1G1D display panel may show bright and dark stripes in the first direction OX. It will be noted that, cyan light is obtained by mixing green light and blue light in equal proportions. That is, when a certain pixel in the display panel emits cyan light, a blue sub-pixel and a green sub-pixel thereof emit light, and a red sub-pixel thereof does not emit light. Similarly, yellow light is obtained by mixing red light and green light in equal proportions. That is, when a certain pixel in the display panel emits yellow light, a red sub-pixel and a green sub-pixel thereof emit light, and a blue sub-pixel thereof does not emit light.

A reason why bright stripes appear on the image displayed by the 1G1D display panel when the data signals shown in FIGS. 4 and 5 are provided thereto is as follows.

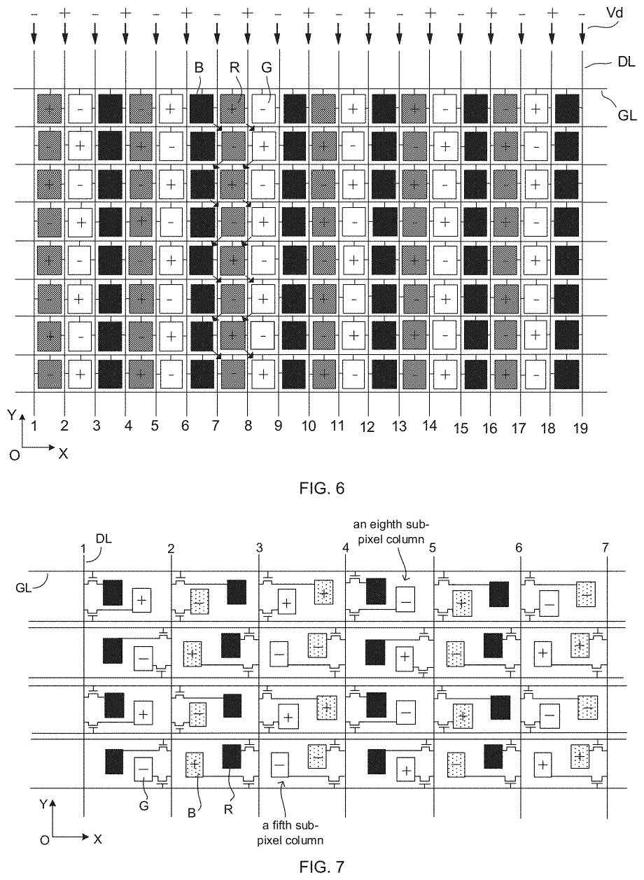

Referring to FIG. 6, in an example where a yellow image is displayed in a frame, blue sub-pixels that do not emit light are represented in black. It will be noted that, since the blue sub-pixels do not need to emit light, a voltage difference between a cathode and an anode of a blue sub-pixel is small (for example, the voltage difference is approximately zero). And, since luminance of red sub-pixels and green sub-pixels needs to reach their respective maximum values, a voltage difference between a cathode and an anode of a green sub-pixel substantially reaches a maximum value, and so does a voltage difference between a cathode and an anode of a red sub-pixel.

Except the first and the last data lines, for datalines with odd sequence numbers, for example, a data line with the sequence number 7, the data line is alternately connected to blue sub-pixels and red sub-pixels from top to bottom in the second direction OY, and a voltage waveform of the data signal Vd transmitted by the data line is as shown in FIG. 4. That is, in the pre-charging period T1 and the charging period T2 of each sub-pixel connected to a data line with an odd sequence number, the data signal Vd is a signal that alternates between a low level and a high level.

For data lines with even sequence numbers, for example, a data line with the sequence number 8, the data line is alternately connected to red sub-pixels and green sub-pixels from top to bottom in the second direction OY, and a voltage waveform of the data signal Vd transmitted by the data line is as shown in FIG. 5. That is, in the pre-charging period T1 and the charging period T2 of each sub-pixel connected to a data line with an even sequence number, the data signal Vd is maintained at a high level or a low level, instead of a signal that alternates between the high level and the low level.

Therefore, as for green sub-pixels connected to a data line with an odd sequence number and green sub-pixels connected to a data line with an even sequence number, since the data signal Vd corresponding to the former is a signal that alternates between the high level and the low level in its pre-charging period T1, and the data signal Vd corresponding to the latter is maintained at a high level or a low level in its pre-charging periods T1 and T2, the latter may be overcharged during the whole charging period (i.e., T1 and T2), which may cause the luminance of the latter to be higher than the luminance of the former in a subsequent display period. That is, the luminance of the green sub-pixels in the odd rows of sub-pixels may be greater than the luminance of the green sub-pixels in the even rows of sub-pixels. Similarly, for a similar reason, the luminance of the red sub-pixels in the even rows of sub-pixels may be greater than the luminance of the red sub-pixels in the odd rows of sub-pixels. In this way, bright and dark stripes extending in the first direction OX may appear on the displayed images.

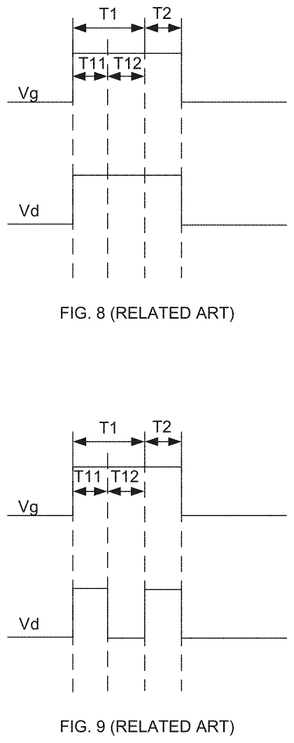

A reason why the bright stripes appear on the image displayed by the 2G2D display panel when the data signals shown in FIGS. 8 and 9 are provided thereto is as follows.

As shown in FIG. 7, in an example where a cyan image is displayed in a frame, red sub-pixels that do not emit light are represented in black. It will be noted that, since the red sub-pixels do not emit light, a voltage difference between a cathode and an anode of a red sub-pixel is small (for example, the voltage difference is approximately zero). And, since luminance of the blue sub-pixels and the green sub-pixels need to reach a maximum value, a voltage difference between a cathode and an anode of a green sub-pixel substantially reaches a maximum value, and so does a voltage difference between a cathode and an anode of a blue sub-pixel.

In this frame, as shown in FIG. 7, for each green sub-pixel in an odd sub-pixel column, e.g., for each green sub-pixel (such as, the green sub-pixel in the third row) in the fifth sub-pixel column, pixel voltage values required by two sub-pixels (such as, a first sub-pixel in a second row and a third column, and a second sub-pixel in a third row and a sixth column) whose connecting points with a third data line DL are located ahead of a connecting point between the green sub-pixel and the third data line DL in the second direction are approximately the same as a voltage value required by the green sub-pixel, and voltages of the two sub-pixels and the voltage of the green sub-pixel are both positive or negative. Waveforms of the data signal Vd of the green sub-pixel in the pre-charging period T1 and the charging period T2 are as shown in FIG. 8. That is, the data signal Vd is maintained at a high level or a low level throughout its pre-charging period T1 and the charging period T2.

As shown in FIG. 7, for each green sub-pixel in an even sub-pixel column, e.g., for each green sub-pixel (such as the green sub-pixel in the fourth row) located in the eighth sub-pixel column, in two sub-pixels (such as a third sub-pixel in a third row and a ninth column, and a fourth sub-pixel in a fourth row and a seventh column) whose connecting points with a fifth data line DL are located ahead of a connecting point between the green sub-pixel and the fifth data line DL in the second direction OY, pixel voltage values required by the third sub-pixel and the green sub-pixel are significantly different from a pixel voltage value required by the fourth sub-pixel. The waveforms of the data signal Vd of the green sub-pixel in the pre-charging period T1 and the charging period T2 are as shown in FIG. 9. That is, the data signal Vd is a signal that alternates between the high level and the low level in its pre-charging period T1.

Similarly to the 1G1D display panel, as shown in FIGS. 8 and 9, each green sub-pixel in the odd sub-pixel column in the 2G2D display panel may be overcharged, which may cause a luminance of each green sub-pixel in the odd sub-pixel column to be greater than a luminance of each green sub-pixel in the even sub-pixel column. For a similar reason, luminance of the blue sub-pixels in the even sub-pixel column may be greater than luminance of the blue sub-pixels in the odd sub-pixel column. In this way, bright and dark stripes extending in the second direction OY may appear on the displayed images.

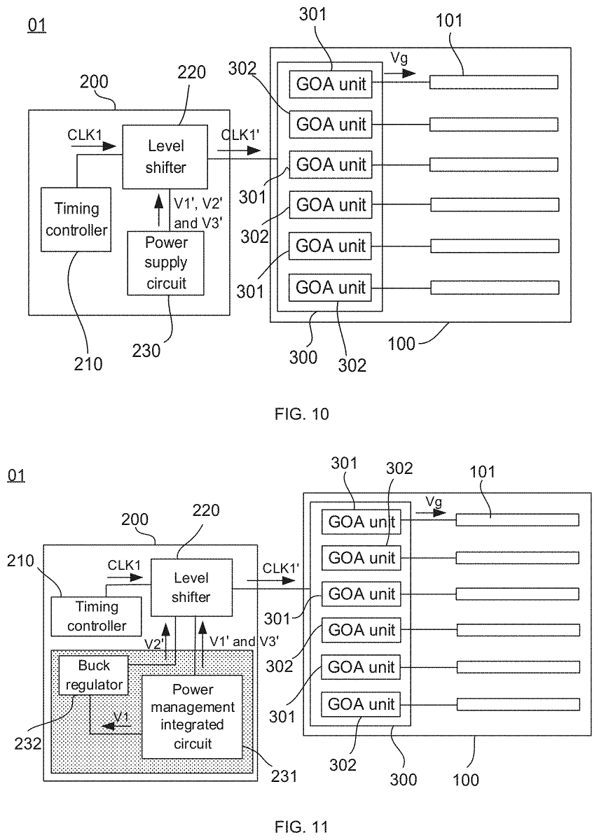

It will be noted that, in the above case, if a pixel column (a pixel column including a column of red sub-pixels, a column of green sub-pixels and a column of blue sub-pixels) is regarded as a basic unit of the display panel, when the data signals shown in FIGS. 9 and 10 are provided to the 2G2D display panel to make the 2G2D display panel display a target image, a display luminance of an odd pixel column may be less than a display luminance of an even pixel column. For example, a third pixel column includes an eighth green sub-pixel column and a ninth blue sub-pixel column, and a second pixel column includes a fifth green sub-pixel column and a sixth blue sub-pixel column. As a result, a display luminance of the third pixel column is lower than a display luminance of the second pixel column.

Some embodiments of the present disclosure provide a display driving system. As shown in FIG. 10, the display driving system 200 includes a timing controller (TCON) 210, a level shifter 220 and a power supply circuit 230.

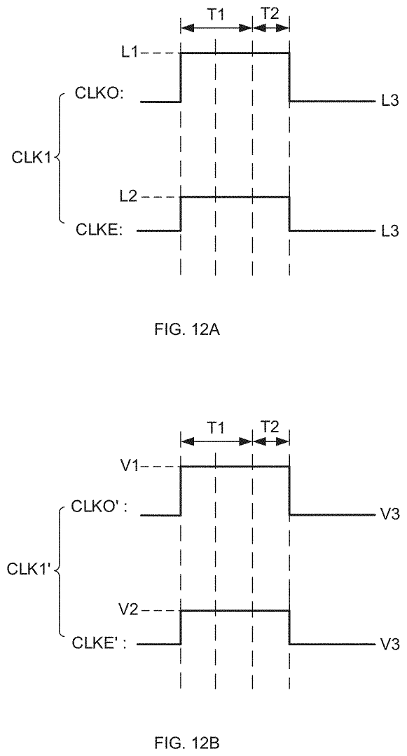

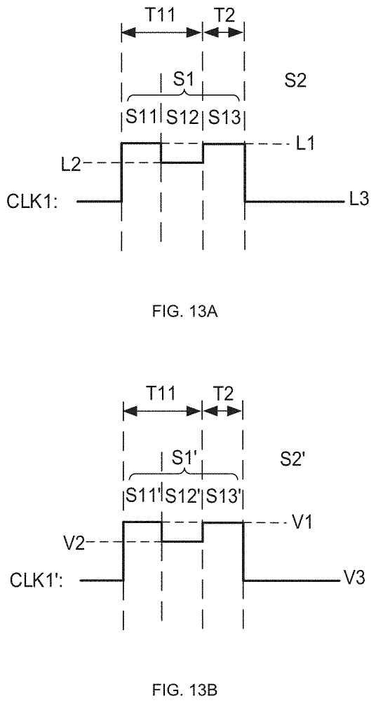

The timing controller 210 is electrically connected to the level shifter 220. The timing controller 210 is configured to send first clock signals CLK1 to the level shifter 220 when an image to be displayed is a target image. As shown in FIGS. 12 and 13, the first clock signals CLK1 have a first level L1, a second level L2 and a third level L3. A voltage of the second level L2 is less than a voltage of the first level L1 and is greater than a voltage of the third level L3.

The power supply circuit 230 is electrically connected to the level shifter 220, and is configured to output a first voltage signal V1′, a second voltage signal V2′ and a third voltage signal V3′ to the level shifter 220. Herein, a second voltage V2 of the second voltage signal V2′ is less than a first voltage V1 of the first voltage signal V1′ and greater than a third voltage V3 of the third voltage signal V3′. It will be understood that the first voltage signal V1′, a second voltage signal V2′ and a third voltage signal V3′ that are provided by the power supply circuit 230 are constant voltage signals.

As shown in FIG. 10, the level shifter 220 is configured to transmit a plurality of first control signals CLK1′ that have the first voltage V1, the second voltage V2 and the third voltage V3 to the gate driver circuit 300 (which may include a plurality of GOA units). The level shifter 220 transmits the first voltage V1 of the plurality of first control signals CLK1′ to the gate driver circuit 300 in response to the first level L1 of the first clock signals CLK1, transmits the second voltage V2 of the plurality of first control signals CLK1′ to the gate driver circuit 300 in response to the second level L2 of the first clock signals CLK1, and transmits the third voltage V3 of the plurality of first control signals CLK1′ to the gate driver circuit 300 in response to the third level L3 of the first clock signals CLK1.

It will be noted that, the first voltage V1 and the second voltage V2 need to be capable of turning on a switching transistor in a corresponding sub-pixel, and the third voltage V3 needs to be capable of turning off the switching transistor. In an example where a switching transistor in each sub-pixel is an N-type transistor, the first voltage V1 and the second voltage V2 are at a high level for turning on the switching transistor, and the third voltage V3 is at a low level for turning off the switching transistor.

For example, the first voltage V1 is in a range from 31 V to 40 V, the second voltage V2 is in a range from 23 V to 29 V, and the third voltage V3 is in a range from −3 V to −12V.

For example, the first voltage V1 may be 32 V, 35 V or 38 V. The second voltage V2 may be 24 V, 26 V, or 28 V. The third voltage V3 may be −5 V, −7 V or −10 V.

In the display driving system 200, the first level L1 and the second level L2 may be used as a high level of the first clock signal CLK1, and the third level L3 may be used as a low level of the first clock signal CLK1. In this way, when the image to be displayed is a target image, the second level L2 with a lower voltage value (relative to the first level L1) is provided to the level shifter 220, so that the level shifter 220 provides a lower second voltage V2 (relative to the first voltage V1) to a GOA unit corresponding to a sub-pixel row whose green sub-pixel has a data signal Vd maintained at a high level or a low level. In this way, a voltage value of the first scanning signal Vg provided by the corresponding GOA unit to the sub-pixel row is relatively low, which may decrease a magnitude of a current flowing through the corresponding switching transistor in the charging periods T1 and T2, and further reduce a charging degree of the green sub-pixel in the charging periods T1 and T2. That is, by reducing the charging degree of the green sub-pixel in the charging periods T1 and T2, display luminance of the green sub-pixel may be reduced. Therefore, it is possible to reduce an occurrence of bright and dark stripes when the display panel displays a target image.

In some embodiments, the first level L1 is in a range from 2.5 V to 3.3 V, the second level L2 is in a range from 1.2 V to 1.8 V, and the third level L3 is in a range from 0 V to 0.7 V.

For example, the first level L1 may be 2.7 V, 3 V, or 3.2 V; the second level L2 may be 1.4 V, 1.6 V or 1.8 V; the third level L3 may be 0.3 V, 0.5 V or 0.7 V.

For another example, a voltage value of the first level L1 of the first clock signals CLK1 is 3.3 V, a voltage value of the second level L2 of the first clock signals CLK1 is 1.3 V, and a voltage value of the third level L3 of the first clock signals CLK1 is 0 V.

In some embodiments, as shown in FIG. 11, the power supply circuit 230 includes a power management integrated circuit 231 and a buck regulator 232 electrically connected to the power management integrated circuit 231. The power management integrated circuit 231 is electrically connected to the level shifter 220. The power management integrated circuit 231 is configured to output the first voltage signal V1′ and the third voltage signal V3′ to the level shifter 220 and output the first voltage signal V1′ to the buck regulator 232. The buck regulator 232 is electrically connected to the level shifter 220. The buck regulator 232 is configured to convert the first voltage signal V1′ into the second voltage signal V2′ and transmit the second voltage signal V2′ to the level shifter 220.

For example, the buck regulator 232 may be a low dropout regulator (LDO) or a buck converter.

It will be understood that, in the 1G1D display panel, when the data signals Vd shown in FIGS. 4 and 5 are provided, whether luminance of green sub-pixels in odd sub-pixel rows or luminance of green sub-pixels in even sub-pixel rows is greater depends on how the sub-pixels of the display panel are connected to date lines DL and how the sub-pixels are arranged.

For example, as shown in FIG. 6, from left to right along the first direction OX, the red sub pixel, the green sub-pixel and the blue sub-pixel are sequentially and periodically arranged, and sub-pixels in the first sub-pixel row are connected to data lines DL located at their respective right sides. In this case, green sub-pixels in odd sub-pixel rows may have greater luminance than green sub-pixels in even sub-pixel rows when the display panel displays a target image.

In a case where a sequence in which the different color sub-pixels are arranged is changed, and/or sub-pixels in the first sub-pixel row are connected to data lines DL at their respective left sides, the green sub-pixels in even sub-pixel rows may have greater luminance than green sub-pixels in odd sub-pixel rows when the display panel displays a target image.

For example, from left to right along the first direction OX, the red sub pixel, the green sub-pixel and the blue sub-pixel are sequentially and periodically arranged, and sub-pixels in the first sub-pixel row are connected to data lines DL located at their respective left sides. In this case, green sub-pixels in even sub-pixel rows may have greater luminance than green sub-pixels in odd sub-pixel rows when the display panel displays a target image.

On this basis, as shown in FIGS. 10 and 11, in some embodiments, the gate driver circuit 300 includes a plurality of GOA units, and the plurality of GOA units include a plurality of first GOA units 301 and a plurality of second GOA units 302. The first GOA unit 301 is configured to provide a first scanning sub-signal VgS1 to one of an odd sub-pixel row (i.e., a sub-pixel row with an odd sequence number) and an even pixel row (i.e., a sub-pixel row with an even sequence number), and the second GOA unit 302 is configured to provide a second scanning sub-signal VgS2 to another of the odd sub-pixel row and the even pixel row. As shown in FIG. 12A, the first clock signals CLK1 include a plurality of first sub-clock signals CLKO and a plurality of second sub-clock signals CLKE. The first sub-clock signal CLKO has the first level L1 and the third level L3, and the second sub-clock signal CLKE has the second level L2 and the third level L3.

As shown in FIG. 12B, the first control signals CLK1′ includes a plurality of first sub-control signals CLKO′ and a plurality of second sub-control signals CLKE′. The first sub-control signal CLKO′ has the first voltage V1 and the third voltage V3, and the second sub-control signal CLKO′ has the second voltage V2 and the third voltage V3.

The level shifter 220 is configured to: transmit the first voltages V1 of the first sub-control signals CLKO′ to the first GOA units in response to the first levels L1 of the first sub-clock signals CLKO; transmit the second voltages V2 of the second sub-control signals CLKE′ to the second GOA units in response to the second levels of the second sub-dock signals CLKE; and transmit the third voltages V3 of the first sub-control signals CLKO′ and the second sub-control signals CLKE′ to the first GOA units and the second GOA units in response to the third levels L3 of the first sub-clock signals CLKO and the third levels L3 of the second sub-clock signals CLKE, respectively.

Here, as shown in FIG. 6, the display driving system will be illustrated by taking an example where each first GOA unit is configured to provide the first scanning sub-signal VgS1 to an odd sub-pixel row and each second GOA unit is configured to provide the second scanning sub-signal VgS2 to an even sub-pixel row, and sub-pixels in the first sub-pixel row are connected to data lines DL located at their respective right sides. Here, the first GOA unit is represented as a (2N−1)-th GOA unit, and the second GOA unit is represented as a 2N-th GOA unit. N is a positive integer.

The first sub-clock signal CLKO has the first level L1 and the third level L3, and the second sub-clock signal CLKE has the second level L2 and the third level L3. The first sub-control signal CLKO′ has the first voltage V1 and the third voltage V3, and the second sub-control signal CLKE′ has the second voltage V1 and the third voltage V3. In this case, the level shifter 220 is configured to: transmit a first voltage V1 of a first sub-control signal CLKO′ to a (2N−1)-th GOA unit of the plurality of GOA units in response to a first level L1 of a first sub-clock signal CLKO, transmit a second voltage V2 of a second sub-control signal CLKE′ to a 2N-th GOA unit of the plurality of GOA units in response to a second level L2 of a second sub-clock signal CLKE, and transmit a third voltage V3 of the first sub-control signal CLKO′ and a third voltage V3 of the second sub-control signal CLKE′ to the (2N−1)-th GOA unit and the 2N-th GOA unit in response to the third level L3 of the first sub-clock signal CLKO and the third level L3 of the second sub-clock signal CLKE, respectively.

In this way, in a case where the display panel is the 1G1D display panel, by separately providing control signals with different high voltages (i.e., the first voltage V1 and the second voltage V2) to the GOA units corresponding to the odd sub-pixel rows and the even sub-pixel rows, first scanning signals Vg with different voltage values (i.e., the first scanning sub-signal VgS1 and the second scanning sub-signal VgS2) may be supplied to odd sub-pixel rows and even sub-pixel rows during the charging periods T1 and T2, respectively, so that the charging degree of each green sub-pixel in the odd sub-pixel rows in the charging periods T1 and T2 may be reduced, which may reduce the luminance of the green sub-pixels in the odd sub-pixel rows when the display panel displays a target image.

In some other embodiments, compared with the above case where green sub-pixels in odd sub-pixel rows have greater illuminance, in a case where green sub-pixels in even sub-pixel rows have greater illuminance, the difference lies in that each first GOA unit is configured to provide the first scanning sub-signal VgS1 to an even sub-pixel row, and each second GOA unit is configured to provide the second scanning sub-signal VgS2 to an odd sub-pixel row. In this way, the luminance of the green sub-pixels in the even sub-pixel rows may be reduced when the display panel displays a target image, and reference may be made to the above description.

In some embodiments, as shown in FIG. 13A, a cycle of each first clock signal CLK1 includes a high-level clock period S1 and a low-level clock period S2. The high-level clock period S1 includes at least a first high-level clock sub-period S11 and a second high-level clock sub-period S12 adjacent thereto, and the first high-level clock sub-period S11 and the second high-level clock sub-period S12 are sequentially arranged. The first clock signal CLK1 has the first level L1 in the first high-level clock sub-period S11, has the second level L2 in the second high-level clock sub-period S12, and has the third level L3 in the low-level clock period S2.

In this case, as shown in FIG. 13B, a cycle of each first control signal CLK1′ includes a high-level control period S1′ and a low-level control period S2′; the high-level control period S1′ includes at least a first high-level control sub-period S11′ and a second high-level control sub-period S12′ adjacent thereto, and the first high-level control sub-period S11′ and the second high-level control sub-period S12′ are sequentially arranged; the first control signal CLK1′ has the first voltage V1 in the first high-level control sub-period S11′, has the second voltage V2 in the second high-level control sub-period S12′, and has the third voltage V3 in the low-level control period S2′.

The level shifter 220 is configured to: transmit the first voltage V1 of the first control signals CLK1′ in the first high-level control sub-period S11′ to the gate driver circuit 300 in response to the first level L1 of the first clock signals CLK1 in the first high-level clock sub-period S11, transmit the second voltage V2 of the first control signals CLK1′ in the second high-level control sub-period S12′ to the gate driver circuit 300 in response to the second level L2 of the first clock signals CLK1 in the second high-level clock sub-period S12, and transmit the third voltage V3 of the first control signals CLK1′ in the low-level control period S2′ to the gate driver circuit 300 in response to the third level L3 of the first clock signals CLK1 in the low-level clock period S2.

In this way, in a case where the display panel is the 2G2D display panel, second voltage V2 with a low voltage value is provided to the gate driver circuit 300 in the second high-level control sub-period S12′, which may reduce a voltage of the first scanning signal Vg of each green sub-pixel whose data signal Vd is maintained at a high level or a low level in the charging periods T1 and T2, thereby reducing the charging degree of the green sub-pixels in the charging periods T1 and T2 to reduce the luminance of the green sub-pixels.

On this basis, in some embodiments, as shown in FIG. 13A, the high-level clock period S1 of the first clock signal CLK1 further includes a third high-level clock sub-period S13 that is adjacent to and subsequent to the second high-level clock sub-period S12, and the first clock signal CLK1 has the first level L1 in the third high-level clock sub-period S13. In this case, the high-level control period S1′ of the first control signal CLK1′ further includes a third high-level control sub-period S13′ that is adjacent to and subsequent to the second high-level control sub-period S12′, and the first control signal CLK1′ has the first voltage V1 in the third high-level control sub-period S13′.

The level shifter 220 is further configured to transmit the first voltage V1 of the first control signals CLK1′ in the third high-level control sub-period S13′ to the gate driver circuit 300 in response to the first level L1 of the first clock signals CLK1 in the third high-level clock sub-period S13.

In some embodiments, the timing controller 210 is a timing controller with a pattern detection function. The timing controller 210 is further configured to: obtain image data corresponding to the image to be displayed, determine a ratio of a number of target pixels in the image to be displayed to the total number of pixels in the image to be displayed according to the image data, and determine that the image to be displayed is a target image when the ratio is greater than a set value.

For example, the timing controller 210 receives image data from system on chip (SOC), or retrieves image data from, for example, a storage medium of the display device.

Herein, each pixel of the image to be displayed includes three color components corresponding to three sub-pixels in a pixel of the display panel. The target pixel is a pixel of the image whose two of the three color components are both greater than or equal to a first threshold, and one of the two color components is a green color component; and the remaining color component is less than or equal to a second threshold. Herein, the first threshold is greater than the second threshold. It will be understood that, besides the green color component, each pixel of the image to be displayed further includes a blue color component and a red color component.

It will be noted that, a pixel of the image to be displayed refers to a minimum unit constituting the image, which is a different concept from a pixel having a physical structure in the display panel.

Herein, the image data received by the timing controller 210 may include pixel data of the image to be displayed, a clock signal and a control signal. The pixel data may include data such as color components of pixels in the image to be displayed, and types of the color components (e.g., red color component, blue color component and green color component) of each pixel in the image to be displayed. The clock signal may be used to indicate a timing of changes of states of the sub-pixels in a certain row of sub-pixels of the display panel when images are displayed. The control signal may include a start vertical (STV) signal for controlling a turn-on or turn-off state of a sub-pixel row, and a voltage signal VDD for supplying a voltage to the gate driver circuit 300. Voltage signals VDD may be used, for example, to reset the GOA units included in the gate driver circuit 300.

In addition, the set value described above may be set according to actual requirements. For example, the set value may be set by a user to be lower; and the set value may be set by the user to be higher.

For example, the set value is 70%, that is, in a case where the above ratio of an image to be displayed is greater than or equal to 70%, the timing controller 210 determines that the image to be displayed is a target image.

In some embodiments, the target pixel is a pixel in which the two color components including the green color component are greater than or equal to the maximum value, and the remaining color component is equal to or approximately equal to the minimum value. It will be understood that the maximum value corresponds to a maximum brightness of a sub-pixel of the display panel, and the minimum value corresponds to a minimum brightness of the sub-pixel of the display panel. For example, each color component has 256 levels: from the minimum value, i.e., 0, to the maximum value, i.e., 255. When a sub-pixel is at its maximum brightness, the color component corresponding to this sub-pixel is 255, and when the sub-pixel is at its minimum brightness, the color component corresponding to this sub-pixel is 0.

For example, in a case where the color component is in a range from 0 to 255, the two color components including the green color component in the target pixel are equal to or approximately equal to 255, and the remaining color component in the target pixel is equal to or approximately equal to 0.

In some embodiments, when the image to be displayed is not a target image, the timing controller 210 sends a plurality of second clock signals CLK2 to the level shifter 220, and the second clock signals CLK2 have the first level L1 and the third level L3. The power supply circuit 230 is further configured to output the first voltage signal V1′ and the third voltage signal V3′ to the level shifter 220; the level shifter 220 is further configured to transmit a plurality of second control signals CLK2′ each of which has the first voltage V1 and the third voltage V3 to the GOA units, which includes: transmitting the first voltage V1 of the plurality of second control signals CLK2′ to the gate driver circuit 300 in response to the first level L1 of the second clock signals CLK2, and transmitting the third voltage V3 of the plurality of second control signals CLK2′ to the gate driver circuit 300 in response to the third level L3 of the second clock signals CLK2.

In this way, when the target image is not displayed, i.e., when each green sub-pixel of the display panel does not have a data signal Vd that is maintained at a high level or a low level in the charging periods T1 and T2, only a first voltage V1 with a relatively high voltage value may be transmitted to each GOA unit. Therefore, when a target image is not displayed, a charging condition of each sub-pixel may not be affected.

In some embodiments, a display device is provided. As shown in FIG. 10, the display device 01 includes a display panel 100 and the display driving system 200. The display panel 100 includes a plurality of sub-pixel rows 101 and at least one gate driver circuit 300, and each gate driver circuit 300 includes a plurality of GOA units. Each GOA unit is electrically connected to a respective one of the plurality of sub-pixel rows 101. The GOA units are configured to provide first scanning signals Vg to the sub-pixel rows 101 according to first control signals CLK1′ provided by the display driving system 200 when the image to be displayed is a target image. The first control signals CLK1′ have the first voltage V1, the second voltage V2 and the third voltage V3.

Since the display device 01 includes the display driving system 200, it has the same beneficial effects as the display driving system 200. Since the beneficial effects have been described in detail in the description of the display driving system 200, they will not be repeated herein.

In some embodiments, referring to the structure of the driving system 200 in FIG. 10, when the image to be displayed is not the target image, the timing controller 210 is further configured to send a plurality of second clock signals CLK2 to the level shifter 220, the second clock signals CLK2 have the first level L1 and the third level L3. In this case, the power supply circuit 230 is further configured to output the first voltage signal V1′ and the third voltage signal V3′ to the level shifter 220; the level shifter 220 is further configured to transmit a plurality of second control signals CLK2′ that have the first voltages V1 and the third voltages V3 to the GOA units, which includes: transmitting the first voltages V1 of the plurality of second control signals CLK2′ to the GOA units in response to the first levels L1 of the second clock signals CLK2, and transmitting the third voltages V3 of the plurality of second control signals CLK2′ to the GOA units in response to the third levels L3 of the second clock signals CLK2. Each GOA unit is further configured to output a second scanning signal Vg′ to the corresponding sub-pixel row according to a corresponding second control signal CLK2′ provided by the level shifter 220 of display driving system 200.

It will be noted that, the display device 01 may be a display device with a display function, such as a television, a mobile phone, a computer monitor, or an electronic reader. The display device may be a thin film transistor-liquid crystal display (TFT-LCD) device, or an organic light-emitting diode (OLED) display device. The organic light-emitting diode display device is, for example, an active-matrix organic light-emitting diode (AMOLED) display device.

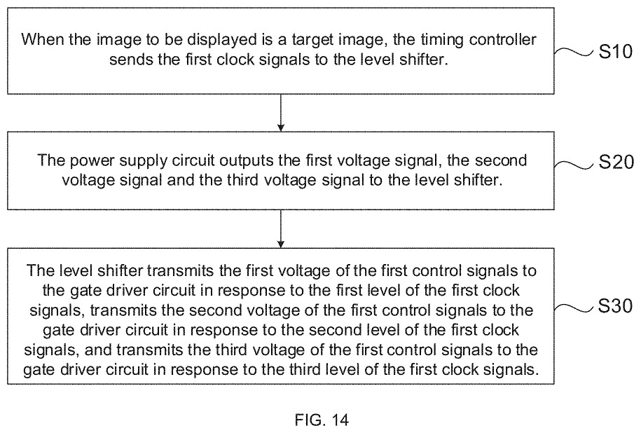

Some embodiments of the present disclosure provide a display driving method. The display driving method may be performed at the display driving system 200. As shown in FIGS. 10 and 14, the method includes the following S10 to S30.

In S10, when the image to be displayed is a target image, the timing controller 210 sends the first clock signals CLK1 to the level shifter 220. The first clock signals CLK1 have the first level L1, the second level L2 and the third level L3. The voltage of the second level L2 is less than the voltage of the first level L1 and greater than the voltage of the third level L3.

In S20, the power supply circuit 230 outputs the first voltage signal V1′, the second voltage signal V2′ and the third voltage signal V3′ to the level shifter 220. The second voltage V2 of the second voltage signal V2′ is less than the first voltage V1 of the first voltage signal V1′ and greater than the third voltage V3 of the third voltage signal V3′.

In S30, the level shifter 220 transmits the first voltage V1 of the first control signals CLK1′ to the gate driver circuit 300 in response to the first level L1 of the first clock signals CLK1, transmits the second voltage V2 of the first control signals CLK1′ to the gate driver circuit 300 in response to the second level L2 of the first clock signals CLK1, and transmits the third voltage V3 of the first control signals CLK1′ to the gate driver circuit 300 in response to the third level L3 of the first clock signals CLK1.

It will be noted that, the first level L1 and the second level L2 may serve as high levels of the first clock signals CLK1, and the third level L3 may serve as a low level of the first clock signals CLK1. When the image to be displayed is a target image, by using the display driving method, the level shifter 220 may be made to provide a lower second voltage V2 (relative to the first voltage V1) to a GOA unit of the gate driver circuit 300 corresponding to each green sub-pixel whose data signal Vd is maintained at a high level or a low level. In this way, a charging degree of the green sub-pixel in the pre-charging period T1 may be reduced, so that the display luminance of the green sub-pixel may be reduced. Therefore, when the display panel displays the target image, the occurrence of bright and dark stripes may be reduced.

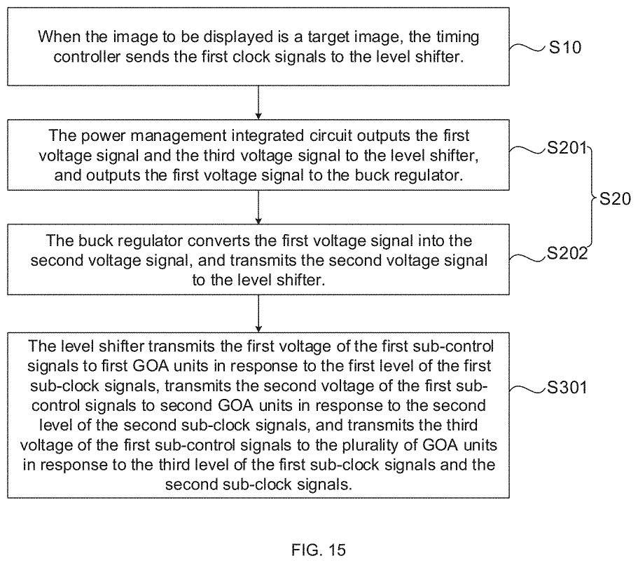

In some embodiments, as shown in FIG. 11, in a case where the power supply circuit 230 includes a power management integrated circuit 231 and a buck regulator 232 that are electrically connected to the power management integrated circuit 231, referring to FIG. 15, the S20, in which the power supply circuit 230 outputs the first voltage signal V1′, the second voltage signal V2′ and the third voltage signal V3′ to the level shifter 220, includes the following S201 and S202.

In S201, the power management integrated circuit 231 outputs the first voltage signal V1′ and the third voltage signal V3′ to the level shifter 220, and outputs the first voltage signal V1′ to the buck regulator 232.

In S202, the buck regulator 232 converts the first voltage signal V1′ into the second voltage signal V2′, and transmits the second voltage signal V2′ to the level shifter 220.

In some embodiments, as shown in FIG. 12A, the first clock signals CLK1 includes a plurality of first sub-clock signals CLKO and a plurality of second sub-clock signals CLKE. Each first sub-clock signal CLKO has the first level L1 and the third level L3, and each second sub-clock signal CLKE has the second level L2 and the third level L3. The plurality of GOA units include a plurality of first GOA units and a plurality of second GOA units. The first GOA unit is configured to provide a first scanning sub-signal VgS1 to one of odd sub-pixel rows and even pixel rows, and the second GOA unit is configured to provide a second scanning sub-signal VgS2 to another of the odd sub-pixel rows and the even pixel rows. The first control signals CLK1′ include a plurality of first sub-control signals CLKO′ and a plurality of second sub-control signals CLKE′, each first sub-control signal CLKO′ has the first voltage V1 and the third voltage V3, and each second sub-control signal CLKE′ has the second voltage V2 and the third voltage V3.

Referring to FIGS. 10, 12A, 12B and 15, the S30, in which the level shifter 220 transmits the first voltage V1 of the first control signals CLK1′ to the gate driver circuit 300 in response to the first level L1 of the first clock signals CLK1, transmits the second voltage V2 of the first control signals CLK1′ to the gate driver circuit 300 in response to the second level L2 of the first clock signals CLK1, and transmits the third voltage V3 of the first control signals CLK1′ to the gate driver circuit 300 in response to the third level L3 of the first clock signals CLK1, includes the following S301.

In S301, the level shifter 220 transmits the first voltages V1 of the first sub-control signals CLKO′ to the first GOA units 301 in the plurality of GOA units of the gate driver circuit 300 in response to the first levels L1 of the first sub-clock signals CLKO, so that each first GOA unit 301 provides a first scanning sub-signal VgS1 to one of odd sub-pixel rows and even pixel rows of the display panel 100; the level shifter 220 transmits the second voltages V2 of the second sub-control signals CLKE′ to the second GOA units 302 in response to the second levels L2 of the second sub-clock signals CLKE, so that each second GOA unit 302 provides a second scanning sub-signal VgS2 to another of the odd sub-pixel rows and the even pixel rows of the display panel 100; and the level shifter 220 transmits the third voltages V3 of the first sub-control signals CLKO′ and the second sub-control signals CLKE′ to the plurality of GOA units of the gate driver circuit 200 in response to the third levels L3 of the first sub-clock signals CLKO and the third levels L3 of the second sub-clock signals CLKE.

In some other embodiments, as shown in FIGS. 10, 13A, 13B and 16, a cycle of each first clock signal CLK1 includes a high-level clock period S1 and a low-level dock period S2. The high-level dock period S1 includes at least a first high-level clock sub-period S11 and a second high-level dock sub-period S12 that are adjacent to the first high-level dock sub-period S11, and the first high-level dock sub-period S11 and the second high-level clock sub-period S12 are sequentially arranged. The first clock signal CLK1 has the first level L1 in the first high-level dock sub-period S11, has the second level L2 in the second high-level clock sub-period S12, and has the third level L3 in the low-level dock period S2. A cycle of each first control signal CLK1′ includes a high-level control period S1′ and a low-level control period S2′. The high-level control period S1′ includes at least a first high-level control sub-period S11′ and a second high-level control sub-period S12′ adjacent thereto, and the first high-level control sub-period S11′ and the second high-level control sub-period S12′ are sequentially arranged. The first control signal CLK1′ has the first voltage V1 in the first high-level control sub-period S11′, has the second voltage V2 in the second high-level control sub-period S12′, and has the third voltage V3 in the low-level control period S2′.

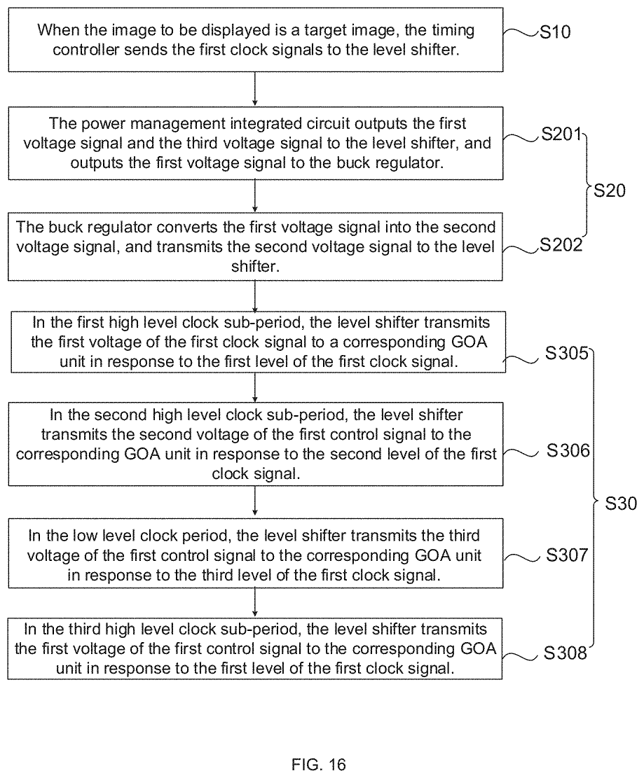

Referring to FIG. 16, the S30, in which the level shifter 220 transmits the first voltage V1 of the plurality of first control signals CLK1′ to the gate driver circuit 300 in response to the first level L1 of the first clock signals CLK1, transmits the second voltage V2 of the plurality of first control signals CLK1′ to the gate driver circuit 300 in response to the second level L2 of the first dock signals CLK1, and transmits the third voltage V3 of the plurality of first control signals CLK1′ to the gate driver circuit 300 in response to the third level L3 of the first clock signals CLK1, includes the following S305 to S307.

In S305, in the first high-level clock sub-period S11 of the first clock signal CLK1, the level shifter 220 transmits the first voltage V1 of the first control signal CLK1′ in the first high-level control sub-period S11′ to a corresponding GOA unit in response to the first level L1 of the first clock signal CLK1.

In S306, in the second high-level clock sub-period S12 of the first clock signal CLK1, the level shifter 220 transmits the second voltage V2 of the first control signal CLK1′ in the second high-level control sub-period S12′ to the corresponding GOA unit in response to the second level L2 of the first clock signal CLK1.

In S307, in the low-level clock period S2, the level shifter 220 transmits the third voltage V3 of the first control signal CLK1′ in the low-level control period S2′ to the corresponding GOA unit in response to the third level L3 of the first clock signal CLK1.

On this basis, in some embodiments, as shown in FIG. 13A, the high-level clock period S1 of the first clock signal CLK1 further includes a third high-level clock sub-period S13 that is adjacent to and subsequent to the second high-level clock sub-period S12, and the first clock signal CLK1 has the first level L1 in the third high-level clock sub-period S13. The high-level control period S1′ of the first control signal CLK1′ further includes a third high-level control sub-period S13′ that is adjacent to and subsequent to the second high-level control sub-period S12′, and the first control signal CLK1′ has the first voltage V1 in the third high-level control sub-period S13′.

Referring to FIG. 16, the S30, in which the level shifter 220 transmits the first voltage V1 of the first control signal CLK1′ to the gate driver circuit 300 in response to the first level L1 of the first clock signals CLK1, transmits the second voltage V2 of the first control signal CLK1′ to the gate driver circuit 300 in response to the second level L2 of the first clock signals CLK1, and transmits the third voltage V3 of the first control signal CLK1′ to the gate driver circuit 300 in response to the third level L3 of the first clock signals CLK1, further includes the following S308 after S307.

In S308, in the third high-level clock sub-period S13 of the first clock signal CLK1, the level shifter 220 transmits the first voltage V1 of the first control signal CLK1′ in the third high-level control sub-period S13′ to the corresponding GOA unit in response to the first level L1 of the first clock signal CLK1.

For example, the voltage of the first level L1 is in a range from 2.5 V to 3.3 V, the voltage of the second level L2 is in a range from 1.2 V to 1.8 V, and the voltage of the third level L3 is in a range from 0 V to 0.7 V.

For example, the voltage of the first level L1 may be 2.7 V, 3 V, or 3.2 V; the voltage of the second level L2 may be 1.4 V, 1.6 V or 1.8 V; the voltage of the third level L3 may be 0.3V, 0.5V or 0.7V.

For example, a voltage of the first level L1 is 3.3 V, a voltage of the second level is 1.3 V, and a voltage of the third level L3 is 0 V.

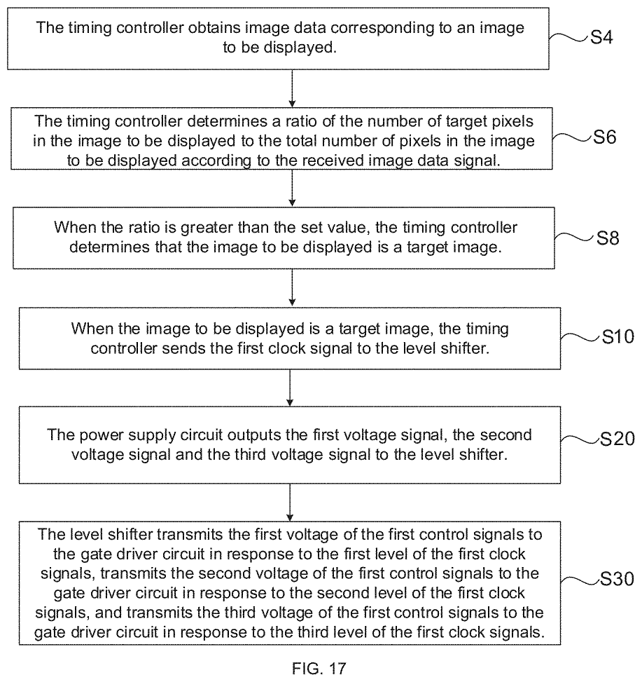

In some embodiments, as shown in FIG. 10, the timing controller 210 is a timing controller with a pattern recognition function. Referring to FIG. 17, before the S10, in which the timing controller 210 sends the first clock signals CLK1 to the level shifter 220, the display driving method further includes the following S4, S6 and S8.

In S4, the timing controller 210 obtains image data corresponding to an image to be displayed.

For example, the timing controller 210 receives image data from system on chip (SOC), or retrieves image data from, for example, a storage medium of the display device.

The storage medium may be a read-only memory (ROM) or other types of static storage devices capable of storing static information, a random access memory (RAM) or other types of dynamic storage devices capable of storing information. The memory may also be an electrically erasable programmable read-only memory (EEPROM), a compact disc read-only memory (CD-ROM) or other optical disk storages, optical disc storages (including compact disc, laser disc, optical disc, digital versatile optical disc, Blu-ray disc, etc.), magnetic disk storage media or other magnetic storage devices, or any other media that can be used to carry or store desired program codes in form of data structures and can be accessed by a computer.

For example, the image data may include pixel data of the image to be displayed, a clock signal and a control signal. The pixel data may include data such as color components of pixels in the image to be displayed, and types of the color components of each pixel in the image to be displayed. The clock signal may be used to indicate a timing of changes of states of the sub-pixels in a certain row of sub-pixels of the display panel when an image is displayed. The control signal may include a start vertical (SW) signal for controlling the turn-on or turn-off state of a sub-pixel row, and a voltage signal VDD for supplying a voltage to the gate driver circuit 300. The voltage signals VDD may be used, for example, to reset the GOA units included in the gate driver circuit 300.

In S6, the timing controller 210 determines a ratio of the number of target pixels in the image to be displayed to the total number of pixels in the image to be displayed according to the obtained image data. Herein, each pixel of the image to be displayed includes three color components corresponding to three sub-pixels in a pixel of the display panel. The target pixel is a pixel in which two of the three color components are both greater than or equal to a first threshold, and a remaining color component is less than or equal to a second threshold, and one of the two color components is a green color component. The first threshold is greater than the second threshold.

It will be understood that, besides the green color component, each pixel of the image to be displayed may further include a blue color component and a red color component.

In S8, when the ratio is greater than a set value, the timing controller 210 determines that the image to be displayed is a target image.

For example, the set value is 70%, the first threshold is 220, and the second threshold is 5. Based on this, in a certain pixel of the image to be displayed, when a red color component and a green color component are both 222, and a blue color component is 3, the pixel is determined to be a target pixel. And in a case where the ratio of the number of target pixels to the total number of pixels in the image to be displayed is, for example, 90%, the image to be displayed is determined as a target image.

The above method will be exemplarily described below with reference to FIGS. 3, 6, 7, 11, 18 and 19. The gate driver circuit 300 includes at least one group of GOA units, and each group of GOA units includes six GOA units (including GOA1 to GOA6). The following description is made by taking an example in which the switching transistors in the GOA units and pixel driver circuits in the sub-pixels of the display panel are N-type transistors (that is, the switching transistors are turned on at a high level and turned off at a low level).

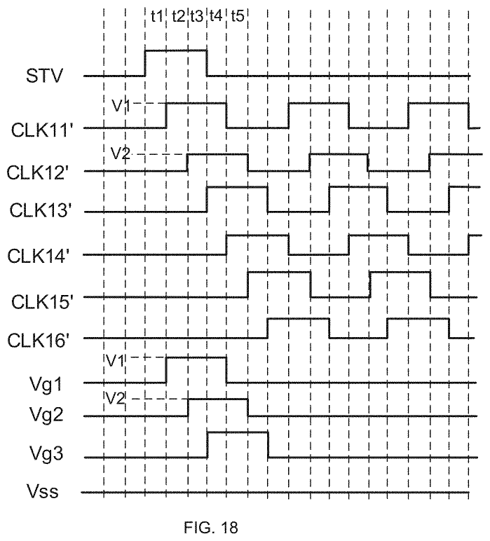

Ina case where the display panel is the 1G1D display panel in FIG. 6 and a group of GOA units of a gate driver circuit 300 is as shown in FIG. 3, referring to FIG. 18, the display driving system 200 sends a first control signal CLK11′ to a first GOA unit GOA1, a first control signal CLK12′ to a second GOA unit GOA2, a first control signal CLK13′ to a third GOA unit GOA3, a first control signal CLK14′ to a fourth GOA unit GOA4, a first control signal CLK15′ to a fifth GOA unit GOA5, and a first control signal CLK16′ to a sixth GOA unit GOA6.

Voltage values of the first control signal CLK11′, the first control signal CLK13′ and the first control signal CLK15′ in their respective high-level control periods are equal to the first voltage V1 of the first voltage signal V1′, and voltage values of the first control signal CLK11′, the first control signal CLK13′ and the first control signal CLK15′ in their respective low-level control periods are equal to the third voltage V3 of the third voltage signal V3. Voltage values of the first control signal CLK12′, the first control signal CLK14′ and the first control signal CLK16′ in their respective high-level control periods are equal to the second voltage V2 of the second voltage signal V2′, and voltage values of the first control signal CLK12′, the first control signal CLK14′ and the first control signal CLK16′ in their respective low-level control periods are equal to the third voltage V3 of the third voltage signal V3′. Correspondingly, after each first control signal CLK1′ is received by a corresponding GOA unit, the GOA unit outputs a first scanning signal Vg to a corresponding sub-pixel row through a corresponding gate line GL. Herein, a waveform of a first scanning signal Vg output by each GOA unit is consistent with and synchronized with a waveform of the first control signal CLK1′ received by the GOA unit.

For example, during periods t2 to t4 shown in FIG. 18, the first control signal CLK11′ received by the first GOA unit GOA1 is at a high level, a first scanning sub-signal VgS1 output by the first GOA unit GOA1 is at a high level, and a voltage value of the first scanning sub-signal VgS1 in its high-level period is equal to the first voltage V1 of the first control signal CLK 11′. For another example, in periods t3 to t5 shown in FIG. 18, the first control signal CLK12′ received by the second GOA unit GOA2 is at a high level, and a second scanning sub-signal VgS2 output by the second GOA unit GOA2 is at a high level, and a voltage value of the scanning sub-signal VgS2 in its high-level period is equal to the second voltage V2 of the first control signal CLK12′.

In this way, the display driving system 200 enables the gate driver circuit 300 to output first scanning signals Vg with different high-level voltages to different sub-pixel rows by outputting the first control signals CLK1′ with different high-level voltages to the GOA units in the gate driver circuit 300.

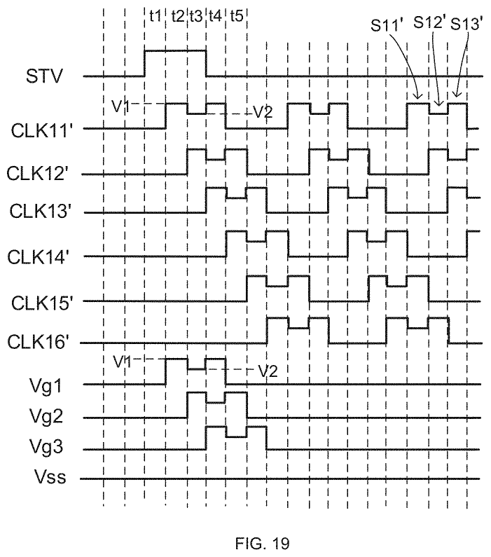

In some other embodiments, the display panel is the 2G2D display panel in FIG. 6 and a group of GOA units of a gate driver circuit 300 is as shown in FIG. 3. Referring to FIG. 19, the display driving system 200 sends the first control signal CLK11′ to the first GOA unit GOA1, the first control signal CLK12′ to the second GOA unit GOA2, the first control signal CLK13′ to the third GOA unit GOA3, the first control signal CLK14′ to the fourth GOA unit GOA4, the first control signal CLK15 to the fifth GOA unit GOA5, and the first control signal CLK16′ to the sixth GOA unit GOA6.

As for each first control signal CLK1′, a voltage value in the first high-level control sub-period S11′ is equal to the first voltage V1 of the first voltage signal V1′, a voltage value in the second high-level control sub-period S12′ is equal to the second voltage V2 of the second voltage signal V2′, a voltage value in the third high-level control sub-period S13′ is equal to the first voltage V1 of the first voltage signal V1′, and a voltage value in the low-level control period S2′ is equal to the third voltage V3 of the third voltage signal V3′. Correspondingly, after each first control signal CLK1′ is received by a corresponding GOA unit, the GOA unit outputs a first scanning signal Vg (i.e., Vg1, Vg2, Vg3, or Vg4) to a corresponding sub-pixel row through a corresponding gate line GL. Herein, a waveform of the first scanning signal Vg output by a GOA unit is consistent with and synchronized with a waveform of the first control signal CLK1′ received by the GOA unit.

For example, in the period t2 shown in FIG. 19, a voltage value of the first control signal CLK11′ received by the first GOA unit GOA1 is equal to the first voltage V1 of the first voltage signal V1′. In the period t3, the voltage value of the first control signal CLK11′ is equal to the voltage value V2 of the second voltage signal V2′. In the period t4, the voltage value of the first control signal CLK11′ is equal to the first voltage V1 of the first voltage signal V1′. In the period t5, the voltage value of the first control signal CLK11′ is equal to the third voltage V3 of the third voltage signal V3′. The GOA unit outputs a first scanning signal Vg1 to a corresponding sub-pixel row through a corresponding gate line GL. For the first scanning signal Vg, a voltage value in the period t2 is equal to V1, the voltage value in the period t3 is equal to V2, the voltage value in the period t4 is equal to V1, and the voltage value in the period t5 is equal to V3.

In this way, the display driving system 200 enables the gate driver circuit 300 to supply different scanning voltages to different sub-pixel rows by outputting the first control signal CLK1′ having different high-level voltage values in different high-level control sub-periods to the GOA units in the gate driver circuit 300.

Each of the timing controller 210, the level shifter 220 and the power supply circuit 230 may be formed using one or more integrated circuits, and/or may be implemented using thin film transistor circuits and/or other circuits.

The forgoing descriptions are merely specific implementations of the present disclosure, but the protection scope of the present disclosure is not limited thereto. Any change or replacement that a person skilled in the art could conceive of within the technical scope of the present disclosure shall be included in the protection scope of the present disclosure. Therefore, the protection scope of the present disclosure shall be subject to the protection scope of the claims.

What is claimed is:

1. A display driving system, comprising a timing controller, a level shifter and a power supply circuit, wherein
the timing controller is electrically connected to the level shifter, and is configured to send a plurality of first clock signals to the level shifter when an image to be displayed is a target image; the first clock signals have a first level, a second level and a third level, and a voltage of the second level is less than a voltage of the first level and is greater than a voltage of the third level;
the power supply circuit is electrically connected to the level shifter, and is configured to output a first voltage signal, a second voltage signal and a third voltage signal to the level shifter; a second voltage of the second voltage signal is less than a first voltage of the first voltage signal and is greater than a third voltage of the third voltage signal; and
the level shifter is configured to transmit a plurality of first control signals that have the first voltage, the second voltage and the third voltage to a gate driver circuit, which includes:
transmitting the first voltage of the plurality of first control signals to the gate driver circuit in response to the first level of the first clock signals;
transmitting the second voltage of the plurality of first control signals to the gate driver circuit in response to the second level of the first clock signals; and
transmitting the third voltage of the plurality of first control signals to the gate driver circuit in response to the third level of the first clock signals.

2. The display driving system according to claim 1, wherein the power supply circuit includes a power management integrated circuit and a buck regulator electrically connected to the power management integrated circuit;
the power management integrated circuit is electrically connected to the level shifter, and is configured to: output the first voltage signal and the third voltage signal to the level shifter, and output the first voltage signal to the buck regulator; and
the buck regulator is electrically connected to the level shifter, and is configured to: convert the first voltage signal into the second voltage signal, and transmit the second voltage signal to the level shifter.

3. The display driving system according to claim 2, wherein the buck regulator is a low dropout regulator or a buck converter.

4. The display driving system according to claim 1, wherein the first clock signals include a plurality of first sub-clock signals and a plurality of second sub-clock signals, each first sub-clock signal has the first level and the third level, and each second sub-clock signal has the second level and the third level; the first control signals include a plurality of first sub-control signals and a plurality of second sub-control signals, each first sub-control signal has the first voltage and the third voltage, and each second sub-control signal has the second voltage and the third voltage; and
the level shifter is configured to:
transmit first voltages of the first sub-control signals to a plurality of first GOA units of the gate driver circuit in response to first levels of the first sub-clock signals, so that each first GOA unit provides a first scanning sub-signal to one of odd sub-pixel rows and even pixel rows;
transmit second voltages of the second sub-control signals to a plurality of second GOA units of the gate driver circuit in response to second levels of the second sub-clock signals, so that each second GOA unit provides a second scanning sub-signal to another of the odd sub-pixel rows and the even pixel rows; and
transmit third voltages of the first sub-control signals and the second sub-control signals to the first GOA units and the second GOA units in response to third levels of the first sub-clock signals and third levels of the second sub-clock signals, respectively.

5. The display driving system according to claim 1, wherein a cycle of each first clock signal includes a high-level clock period and a low-level clock period; the high-level clock period includes at least a first high-level clock sub-period and a second high-level clock sub-period adjacent thereto, and the first high-level clock sub-period and the second high-level clock sub-period are sequentially arranged; the first clock signal has the first level in the first high-level clock sub-period, has the second level in the second high-level clock sub-period, and has the third level in the low-level clock period; a cycle of each first control signal includes a high-level control period and a low-level control period; the high-level control period includes at least a first high-level control sub-period and a second high-level control sub-period adjacent thereto, and the first high-level control sub-period and the second high-level control sub-period are sequentially arranged; the first control signal has the first voltage in the first high-level control sub-period, has the second voltage in the second high-level control sub-period, and has the third voltage in the low-level control period; and the level shifter is configured to: for each first clock signal,
transmit the first voltage of the first control signal in the first high-level control sub-period to the gate driver circuit in response to the first level of the first clock signal in the first high-level clock sub-period;
transmit the second voltage of the first control signal in the second high-level control sub-period to the gate driver circuit in response to the second level of the first clock signal in the second high-level clock sub-period; and
transmit the third voltage of the first control signal in the low-level control period to the gate driver circuit in response to the third level of the first clock signal in the low-level clock period.

6. The display driving system according to claim 5, wherein the high-level clock period of the first clock signal further includes a third high-level clock sub-period that is adjacent to and subsequent to the second high-level clock sub-period, and the first clock signal has the first level in the third high-level clock sub-period; the high-level control period of the first control signal further includes a third high-level control sub-period that is adjacent to and subsequent to the second high-level control sub-period, and the first control signal has the first voltage in the third high-level control sub-period; and
the level shifter is further configured to transmit the first voltage of the first control signal in the third high-level control sub-period to the gate driver circuit in response to the first level of the first clock signal in the third high-level clock sub-period.

7. The display driving system according to claim 1, wherein the voltage of the first level is in a range from 2.5 V to 3.3 V, the voltage of the second level is in a range from 1.2 V to 1.8 V, and the voltage of the third level is in a range from 0 V to 0.7 V.

8. The display driving system according to claim 1, wherein the timing controller is further configured to:
obtain image data corresponding to the image to be displayed;
determine a ratio of a number of target pixels in the image to be displayed to a total number of pixels in the image to be displayed according to the obtained image data, wherein each pixel of the image to be displayed includes three color components, and each target pixel is a pixel in which two of the three color components are both greater than or equal to a first threshold, and a remaining color component is less than or equal to a second threshold; one of the two color components is a green color component, and the first threshold is greater than the second threshold; and
determine that the image to be displayed is the target image when the ratio is greater than a set value.

9. The display driving system according to claim 8, wherein the target pixel is a pixel of the image to be displayed in which two color components are equal to or approximately equal to a maximum value, and a remaining color component is equal to or approximately equal to a minimum value.

10. The display driving system according to claim 1, wherein when the image to be displayed is not the target image,
the timing controller is further configured to send a plurality of second clock signals to the level shifter, wherein each second clock signal has the first level and the third level;
the power supply circuit is further configured to output the first voltage signal and the third voltage signal to the level shifter, and
the level shifter is further configured to transmit a plurality of second control signals each of which has the first voltage and the third voltage to the gate driver circuit, which includes:
transmitting first voltages of the second control signals to the gate driver circuit in response to first levels of the second clock signals; and
transmitting third voltages of the second control signals to the gate driver circuit in response to third levels of the second clock signals.

11. A display driving method performed at a display driving system, the method comprising: when an image to be displayed is a target image,
sending, by a timing controller of the display driving system, a plurality of first clock signals to a level shifter of the display driving system, wherein the first clock signals have a first level, a second level and a third level, and a voltage of the second level is less than a voltage of the first level and is greater than a voltage of the third level;
outputting, by a power supply circuit of the display driving system, a first voltage signal, a second voltage signal and a third voltage signal to the level shifter, wherein a second voltage of the second voltage signal is less than a first voltage of the first voltage signal and is greater than a third voltage of the third voltage signal;
transmitting, by the level shifter, the first voltage of a plurality of first control signals that have the first voltage, the second voltage and the third voltage to a gate driver circuit in response to the first level of the first clock signals;
transmitting, by the level shifter, the second voltage of the plurality of first control signals to the gate driver circuit in response to the second level of the first clock signals; and
transmitting, by the level shifter, the third voltage of the plurality of first control signals to the gate driver circuit in response to the third level of the first clock signals.

12. The display driving method according to claim 11, wherein the power supply circuit includes a power management integrated circuit and a buck regulator electrically connected to the power management integrated circuit; and
outputting, by the power supply circuit, the first voltage signal, the second voltage signal and the third voltage signal to the level shifter includes:
outputting, by the power management integrated circuit, the first voltage signal and the third voltage signal to the level shifter;
outputting, by the power management integrated circuit, the first voltage signal to the buck regulator;
converting, by the buck regulator, the first voltage signal into the second voltage signal; and
transmitting, by the buck regulator, the second voltage signal to the level shifter.

13. The display driving method according to claim 11, wherein the first clock signals include a plurality of first sub-dock signals and a plurality of second sub-clock signals, each first sub-clock signal has the first level and the third level, and each second sub-clock signal has the second level and the third level; the first control signals include a plurality of first sub-control signals and a plurality of second sub-control signals, each first sub-control signal has the first voltage and the third voltage, and each second sub-control signal has the second voltage and the third voltage; and
transmitting, by the level shifter, the first voltage of the plurality of first control signals to the gate driver circuit in response to the first level of the first clock signals, transmitting, by the level shifter, the second voltage of the plurality of first control signals to the gate driver circuit in response to the second level of the first clock signals, and transmitting, by the level shifter, the third voltage of the plurality of first control signals to the gate driver circuit in response to the third level of the first clock signals, include:
transmitting, by the level shifter, first voltages of the first sub-control signals to a plurality of first GOA units of the gate driver circuit in response to first levels of the first sub-clock signals, so that each first GOA unit provides a first scanning sub-signal to one of odd sub-pixel rows and even pixel rows;
transmitting, by the level shifter, second voltages of the first sub-control signals to a plurality of second GOA units of the gate driver circuit in response to second levels of the second sub-clock signals, so that each second GOA unit provides a second scanning sub-signal to another of the odd sub-pixel rows and the even pixel rows; and
transmitting, by the level shifter, third voltages of the first sub-control signals and the second sub-control signals to the first GOA units and the second GOA units in response to third levels of the first sub-clock signals and third levels of the second sub-clock signals, respectively.

14. The display driving method according to claim 11, wherein a cycle of each first clock signal includes a high-level clock period and a low-level clock period; the high-level clock period includes at least a first high-level clock sub-period and a second high-level clock sub-period adjacent thereto, and the first high-level clock sub-period and the second high-level clock sub-period are sequentially arranged; the first clock signal has the first level in the first high-level clock sub-period, has the second level in the second high-level clock sub-period, and has the third level in the low-level clock period; a cycle of each first control signal includes a high-level control period and a low-level control period; the high-level control period includes at least a first high-level control sub-period and a second high-level control sub-period adjacent thereto, and the first high-level control sub-period and the second high-level control sub-period are sequentially arranged; the first control signal has the first voltage in the first high-level control sub-period, has the second voltage in the second high-level control sub-period, and has the third voltage in the low-level control period; and
transmitting, by the level shifter, the first voltage of the plurality of first control signals to the gate driver circuit in response to the first level of the first clock signals, transmitting, by the level shifter, the second voltage of the plurality of first control signals to the gate driver circuit in response to the second level of the first clock signals, and transmitting, by the level shifter, the third voltage of the plurality of first control signals to the gate driver circuit in response to the third level of the first clock signals include: for each first clock signal,
transmitting, by the level shifter, the first voltage of the first control signal in the first high-level control sub-period to the gate driver circuit in response to the first level of the first clock signal in the first high-level clock sub-period;
transmitting, by the level shifter, the second voltage of the first control signal in the second high-level control sub-period to the gate driver circuit in response to the second level of the first clock signal in the second high-level clock sub-period; and
transmitting, by the level shifter, the third voltage of the first control signal in the low-level control period to the gate driver circuit in response to the third level of the first clock signal in the low-level clock period.

15. The display driving method according to claim 14, wherein the high-level clock period of the first clock signal further includes a third high-level clock sub-period that is adjacent to and subsequent to the second high-level dock sub-period, and the first clock signal has the first level in the third high-level clock sub-period; the high-level control period of the first control signal further includes a third high-level control sub-period that is adjacent to and subsequent to the second high-level control sub-period, and the first control signal has the first voltage in the third high-level control sub-period; and
transmitting, by the level shifter, the first voltage of the plurality of first control signals to the gate driver circuit in response to the first level of the first clock signals, transmitting, by the level shifter, the second voltage of the plurality of first control signals to the gate driver circuit in response to the second level of the first clock signals, and transmitting, by the level shifter, the third voltage of the plurality of first control signals to the gate driver circuit in response to the third level of the first clock signals further include: for each first clock signal,
transmitting, by the level shifter, the first voltage of the first control signal in the third high-level control sub-period to the gate driver circuit in response to the first level of the first clock signal in the third high-level clock sub-period.

16. The display driving method according to claim 11, wherein the voltage of the first level is in a range from 2.5 V to 3.3 V, the voltage of the second level is in a range from 1.2 V to 1.8 V, and the voltage of the third level is in a range from 0 V to 0.7 V.

17. The display driving method according to claim 11, wherein before the timing controller sends the first clock signals to the level shifter, the method further comprises:
obtaining, by the timing controller, image data corresponding to the image to be displayed;
determining, by the timing controller, a ratio of a number of target pixels in the image to be displayed to a total number of pixels in the image to be displayed according to the obtained image data, wherein each pixel of the image to be displayed includes three color components, and each target pixel is a pixel in which two of the three color components are both greater than or equal to a first threshold, and a remaining color component is less than or equal to a second threshold; one of the two color components is a green color component, and the first threshold is greater than the second threshold; and
determining, by the timing controller, that the image to be displayed is the target image when the ratio is greater than a set value.

18. A display device, comprising a timing controller, a level shifter, a power supply circuit, a gate driver circuit and a plurality of sub-pixel rows, wherein
the timing controller is electrically connected to the level shifter, and is configured to send a plurality of first clock signals to the level shifter when an image to be displayed is a target image; the first clock signals have a first level, a second level and a third level, and a voltage of the second level is less than a voltage of the first level and is greater than a voltage of the third level;
the power supply circuit is electrically connected to the level shifter, and is configured to output a first voltage signal, a second voltage signal and a third voltage signal to the level shifter; a second voltage of the second voltage signal is less than a first voltage of the first voltage signal and is greater than a third voltage of the third voltage signal;
the level shifter is configured to transmit a plurality of first control signals that have the first voltage, the second voltage and the third voltage to the gate driver circuit, which includes: transmitting the first voltage of the plurality of first control signals to the gate driver circuit in response to the first level of the first clock signals; transmitting the second voltage of the plurality of first control signals to the gate driver circuit in response to the second level of the first clock signals; and transmitting the third voltage of the plurality of first control signals to the gate driver circuit in response to the third level of the first clock signals; and
the gate driver circuit include a plurality of GOA units, each GOA unit is electrically connected to a respective one of the plurality of sub-pixel rows, and the GOA unit is configured to output a first scanning signal to a corresponding sub-pixel row according to a first control signal provided by the level shifter.

19. The display device according to claim 18, wherein the first clock signals includes a plurality of first sub-clock signals and a plurality of second sub-clock signals, each first sub-clock signal has the first level and the third level, and each second sub-clock signal has the second level and the third level; the first control signals include a plurality of first sub-control signals and a plurality of second sub-control signals, each first sub-control signal has the first voltage and the third voltage, and each second sub-control signal has the second voltage and the third voltage; the GOA units include a plurality of first GOA units and a plurality of second GOA units; each first GOA unit is configured to provide a first scanning sub-signal to one of odd sub-pixel rows and even pixel rows, and each second GOA unit is configured to provide a second scanning sub-signal to another of the even sub-pixel rows and the even pixel rows; and
the level shifter is configured to:
transmit first voltages of the first sub-control signals to the first GOA units in response to first levels of the first sub-clock signals, so that each first GOA unit provides a first scanning sub-signal to one of odd sub-pixel rows and even pixel rows;
transmit second voltages of the second sub-control signals to the second GOA units in response to second levels of the second sub-clock signals, so that each second GOA unit provides a second scanning sub-signal to another of the odd sub-pixel rows and the even pixel rows; and
transmit third voltages of the first sub-control signals and the second sub-control signals to the first GOA units and the second GOA units in response to third levels of the first sub-clock signals and third levels of the second sub-clock signals, respectively.

20. The display device according to claim 18, wherein
the timing controller is further configured to send a plurality of second clock signals to the level shifter when the image to be displayed is not the target image; each second clock signal has the first level and the third level;
the power supply circuit is further configured to output the first voltage signal and the third voltage signal to the level shifter,
the level shifter is further configured to transmit a plurality of second control signals each of which has the first voltage and the third voltage to the GOA units, which includes:
transmitting first voltages of the second control signals to the GOA units in response to first levels of the second clock signals; and
transmitting third voltages of the second control signals to the GOA units in response to third levels of the second clock signals; and
each GOA unit is further configured to output a second scanning signal to the corresponding sub-pixel row according to a corresponding second control signal provided by the level shifter.
